(19) United States
(12) Patent Application Publication
(10) Pub. No.: US 2026/0205343 A1
(43) Pub. Date: Jul. 16, 2026

(54) DATA-AIDED DISCRETE FOURIER TRANSFORM-SPREAD-ORTHOGONAL FREQUENCY DIVISION MULTIPLEXING COMMUNICATIONS

(71) Applicant: Samsung Electronics Co., Ltd., Suwon-si (KR)

(72) Inventors: Caleb K. Lo, San Jose, CA (US); Joonyoung Cho, Portland, OR (US); Jianzhong Zhang, Plano, TX (US); Fabrizio Carpi, Dallas, TX (US)

(21) Appl. No.: 19/406,898

(22) Filed: Dec. 2, 2025

Related U.S. Application Data
(60) Provisional application No. 63/746,163, filed on Jan. 16, 2025.

(51) Int. Cl. H04L 27/26; H04L 25/02; H04L 41/16

(52) U.S. Cl. CPC H04L 27/26526; H04L 25/0202; H04L 41/16

(57) ABSTRACT

A method includes receiving, by a first electronic device, a discrete Fourier transform-spread-orthogonal frequency division multiplexing (DFT-s-OFDM) waveform over a band channel from a second electronic device, the DFT-s-OFDM waveform including data and reference signals (RS). The method further includes separating, by the first electronic device, the data and the RS using an AI model. The method further includes generating, by the first electronic device, information about the data based on the separated data and RS using the AI model trained to generate information about input bits.

### CROSS-REFERENCE TO RELATED APPLICATION AND CLAIM OF PRIORITY

The present application claims priority under 35 U.S.C. § 119(e) to U.S. Provisional Patent Application No. 63/746,163 filed on Jan. 16, 2025, which is hereby incorporated by reference in its entirety.

### TECHNICAL FIELD

This disclosure relates generally to wireless networks. More specifically, this disclosure relates to a method and apparatus for data-aided discrete Fourier transform-spread-orthogonal frequency division multiplexing (DFT-s-OFDM) communications.

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance.

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

This disclosure provides apparatuses and methods for data-aided DFT-s-OFDM communications in wireless communication systems.

In one embodiment, a method is provided. The method may include: receiving, by a first electronic device, a discrete Fourier transform-spread-orthogonal frequency division multiplexing (DFT-s-OFDM) waveform over a band channel from a second electronic device, the DFT-s-OFDM waveform including data and reference signals (RS); separating, by the first electronic device, the data and the RS using an AI model; and generating, by the first electronic device, information about the data based on the separated data and RS using the AI model trained to generate information about input bits.

In another embodiment, a first electronic device is provided. The first electronic device may include a memory and a processor operably coupled to the memory. The processor may be configured to: receive a DFT-s-OFDM waveform over a band channel from a second electronic device. The DFT-s-OFDM waveform may include data and RS. The processor may be further configured to separate the data and the RS using an AI model and generate information about the data based on the separated data and RS using the AI model trained to generate information about input bits.

In yet another embodiment, a non-transitory computer readable medium embodying a computer program is provided, The computer program may include program code that, when executed by a processor of a first electronic device, causes the first electronic device to: receive a DFT-s-OFDM waveform over a band channel from a second electronic device. The DFT-s-OFDM waveform may include data and RS. The computer program may include program code that, when executed by the processor, causes the first electronic device to separate the data and the RS using an AI model and generate information about the data based on the separated data and RS using the AI model trained to generate information about input bits.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network in accordance with example embodiments of the present disclosure;

FIG. 2 illustrates an example gNB in accordance with example embodiments of the present disclosure;

FIG. 3 illustrates an example UE in accordance with example embodiments of the present disclosure;

FIG. 4 illustrates an example network device in accordance with example embodiments of the present disclosure;

FIG. 5 illustrates an example RS pattern in one transmission time interval (TTI) in DFT-s-OFDM in accordance with example embodiments of the present disclosure;

FIG. 6 illustrates example modulation constellations that can be used to facilitate the RS overhead reduction in accordance with example embodiments of the present disclosure;

FIG. 7 illustrates an example data-aided communication system in accordance with example embodiments of the present disclosure;

FIG. 8 illustrates an example process of forming input channels to an NN Rx in data-aided DFT-s-OFDM communications in accordance with example embodiments of the present disclosure;

FIG. 9 illustrates an example process of forming input channels to an NN Rx in data-aided DFT-s-OFDM communications in accordance with example embodiments of the present disclosure;

FIGS. 10A-B illustrate an example process of forming input channels to an NN Rx in an example data-aided communication system in accordance with example embodiments of the present disclosure;

FIG. 11 illustrates an example process of data-aided communications performed by an Rx architecture in accordance with example embodiments of the present disclosure;

FIGS. 12A-D illustrate an example architecture of a hybrid frequency-time NN Rx in a data-aided communication system in accordance with example embodiments of the present disclosure;

FIGS. 13A-B illustrate an example process of data-aided communications performed by an Rx architecture in accordance with example embodiments of the present disclosure;

FIG. 14 illustrates an example pipeline of data-aided communications performed by an Rx architecture in accordance with example embodiments of the present disclosure;

FIG. 15 illustrates an example pipeline for data-aided communications performed by an Rx architecture in accordance with example embodiments of the present disclosure;

FIG. 16 illustrates an example pipeline for data-aided communications performed by an Rx architecture in accordance with example embodiments of the present disclosure;

FIG. 17 illustrates an example pipeline for data-aided communications performed by an Rx architecture in accordance with example embodiments of the present disclosure;

FIG. 18 illustrates an example pipeline for data-aided communications performed by an Rx architecture in accordance with example embodiments of the present disclosure;

FIG. 19 illustrates an example pipeline for data-aided communications performed by an Rx architecture in accordance with example embodiments of the present disclosure;

FIG. 20 illustrates an example process of data-aided communications performed by an Rx architecture in accordance with example embodiments of the present disclosure;

FIGS. 21A-C illustrate example processes of data-aided communications performed by an Rx architecture in accordance with example embodiments of the present disclosure;

FIG. 22 illustrates an example process of data-aided communications performed by an Rx architecture in accordance with example embodiments of the present disclosure;

FIGS. 23A-B illustrate an example subcarrier spacing configuration for a data-aided transmission in accordance with example embodiments of the present disclosure;

FIG. 24 illustrates an example method of supporting a subcarrier spacing configuration in accordance with example embodiments of the present disclosure;

FIG. 25 illustrates an example method of supporting a subcarrier spacing configuration in accordance with example embodiments of the present disclosure;

FIG. 26 illustrates an example pipeline for training an NN Rx in a data-aided communication system in accordance with example embodiments of the present disclosure;

FIG. 27 illustrates an example pipeline for training an NN Rx with channel coding operation in a data-aided communication system in accordance with example embodiments of the present disclosure;

FIG. 28 illustrates an example pipeline for training a hybrid frequency-time NN Rx in a data-aided communication system in accordance with example embodiments of the present disclosure;

FIG. 29 illustrates an example method for training a hybrid frequency-time NN Rx for data-aided communications in accordance with example embodiments of the present disclosure;

FIG. 30 illustrates an example pipeline for training a hybrid frequency-time NN Rx in a data-aided communication system with channel encoding in accordance with example embodiments of the present disclosure;

FIG. 31 illustrates an example method for training a hybrid frequency-time NN Rx for data-aided communications with channel encoding in accordance with example embodiments of the present disclosure;

FIG. 32 illustrates an example pipeline for training a hybrid frequency-time NN Rx in a data-aided communication system with other AI/ML (NN) blocks in accordance with example embodiments of the present disclosure;

FIGS. 33A-B illustrate example methods for training a hybrid frequency-time NN Rx and an NN modulator in accordance with example embodiments of the present disclosure;

FIG. 34 illustrates an example architecture of a hybrid frequency-time NN Rx with an AI/ML channel estimator for in a data-aided communication system in accordance with example embodiments of the present disclosure;

FIG. 35 illustrates an example method of data-aided communication performed by an Rx architecture with an AI/ML channel estimator in accordance with example embodiments of the present disclosure;

FIG. 36 illustrates an example architecture for a time-domain AI/ML Rx with an AI/ML channel estimator in a data-aided communication system in accordance with example embodiments of the present disclosure;

FIG. 37 illustrates an example architecture of a time-domain receiver with an AI/ML channel estimator in a data-aided communication system in accordance with example embodiments of the present disclosure;

FIG. 38 illustrates an example architecture of a time-domain AI/ML Rx with an AI/ML channel estimator in a data-aided communication system in accordance with example embodiments of the present disclosure;

FIG. 39 illustrates an example pipeline for training a hybrid frequency-time AI/ML Rx with an AI/ML channel estimator in a data-aided communication system in accordance with example embodiments of the present disclosure;

FIG. 40 illustrates an example method of training a hybrid frequency-time AI/ML Rx with an AI/ML channel estimator in accordance with example embodiments of the present disclosure; and

FIG. 41 illustrates an example flow chart for a method of generating information about input bits in accordance with example embodiments of the present disclosure.

### DETAILED DESCRIPTION

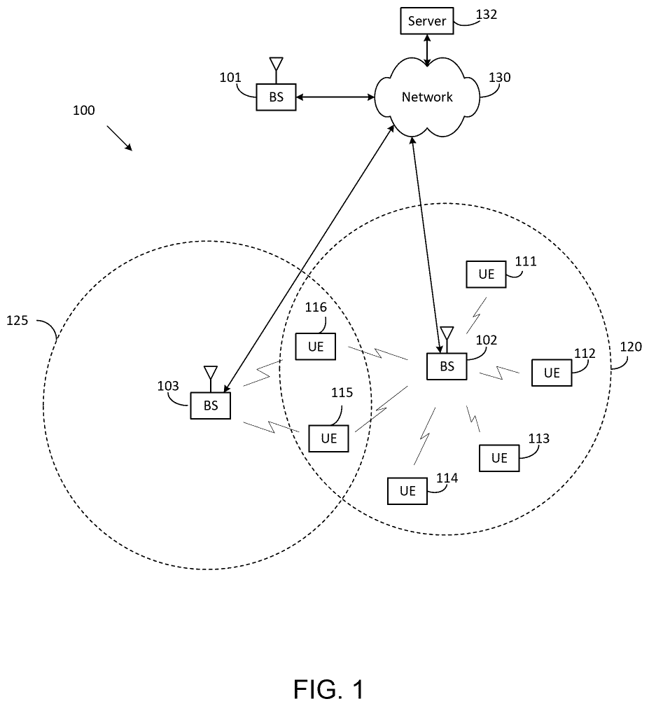

FIGS. 1 through 41, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-4 below describe various embodiments implemented in wireless communications systems and with the use of orthogonal frequency division multiplexing (OFDM) or orthogonal frequency division multiple access (OFDMA) communication techniques. The descriptions of FIGS. 1-4 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

The wireless network 100 may be an artificial intelligence (AI)-based wireless communication system. As such, the at least one network 130 may be operably coupled to an electronic device (e.g., without limitation, a network server) 132 configured to, for example and without limitation, receive data from the gNBs 101-103 and train an AI and/or ML model (hereinafter, also referred to as the AI model) to support data-aided transmissions. The server 132 may represent one or more servers, and each server 132 includes a suitable computing or processing device for training the AI model. Each server 132 could, for example, include one or more processing devices, one or more memories storing instructions and data, and one or more network interfaces to receive the data. The AI model is then trained and deployed to effectively to support data-aided DFT-s-OFDM communications in wireless communication networks 100.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, to support data-aided transmissions in wireless communication systems. In certain embodiments, one or more of the gNBs 101-103 include circuitry, programing, or a combination thereof, to support data-aided transmissions in wireless communication systems.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

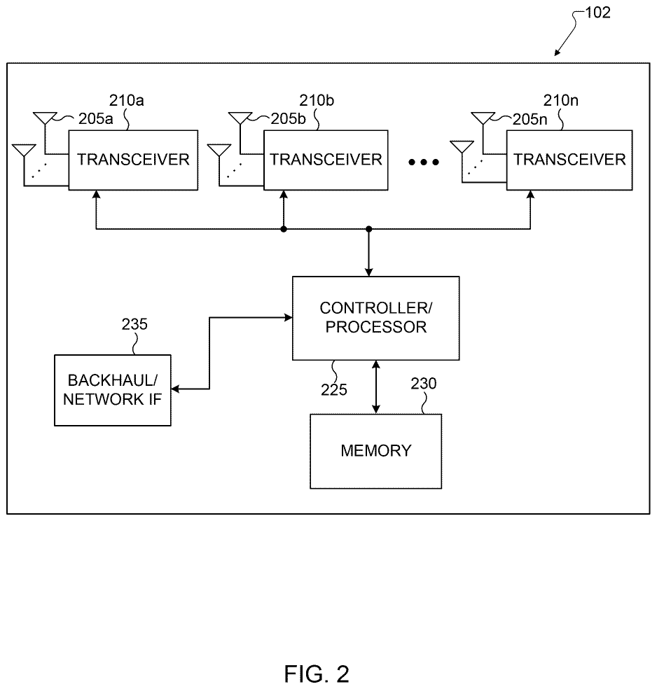

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-convert the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as an OS and, for example, processes to support data-aided DFT-s-OFDM communications in wireless communication networks 100 as discussed in greater detail below. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

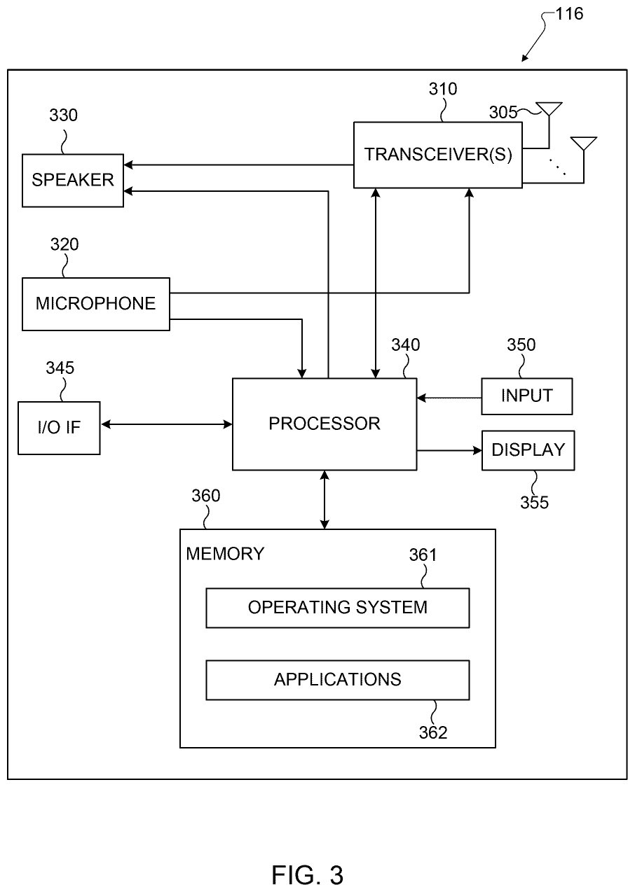

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes to support data-aided DFT-s-OFDM communications in wireless communication networks 100 as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

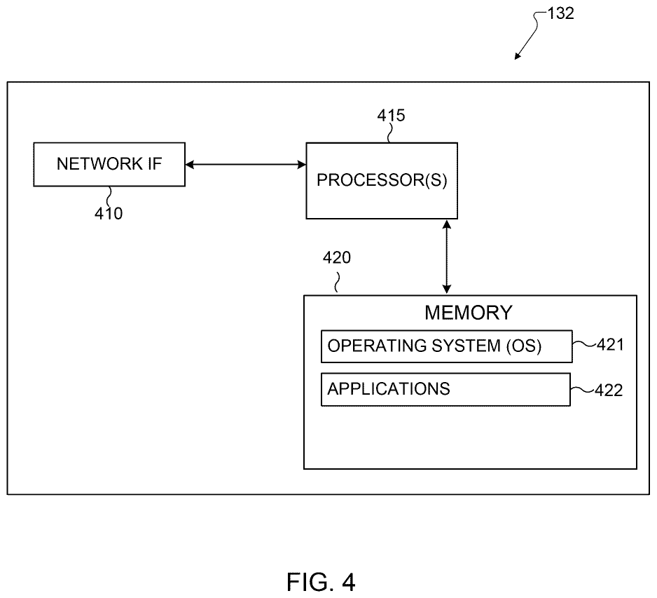

FIG. 4 illustrates an example network server 132 according to embodiments of the present disclosure. The embodiment of the server 132 illustrated in FIG. 4 is for illustration only. Different embodiments of servers 132 could be used without departing from the scope of this disclosure.

The server 132 may be a computing device including at least a network interface 410, a processor 415 and a memory 420. The network interface 410 may support communications over any suitable wired or wireless connection(s). It may include any suitable structure supporting communications over a wired or wireless connection, such as an Ethernet or transceiver. The network interface 410 may be, for example and without limitation, network interface cards (NICs) or network ports. The server 132 may receive data from the gNBs 101-103 via the network interface 410 and the UEs 111-116 via the gNBs 101-103.

The processor 415 is coupled to the network interface 410 and can include one or more processors or other processing devices. The processor 415 can execute instructions that are stored in the memory 420, such as the OS 421 in order to control the overall operation of the server 132. The processor 415 can include any suitable number(s) and type(s) of processors or other devices in any suitable arrangement. For example, in certain embodiments, the processor 415 includes at least one microprocessor or microcontroller. Example types of processor 415 include microprocessors, microcontrollers, digital signal processors, field programmable gate arrays, application specific integrated circuits, and discrete circuitry. In certain embodiments, the processor 415 can include a neural network as well as a CPU, a GPU or a tensor processing unit (TPU) that provides significant computational resources for training the neural network.

The processor 415 is also capable of executing other processes and programs resident in the memory 420, such as operations that receive and store data. As described in greater detail below, the processor 415 may execute processes to train an AI model to support data-aided DFT-s-OFDM communications in wireless communication networks 100. The processor 415 can move data into or out of the memory 420 as required by an executing process. In certain embodiments, the processor 415 is configured to execute the one or more applications 422 based on the OS 421 or in response to signals received from external source(s) or an operator. Example applications 422 can include an AI training application for an AI model.

The memory 420 is coupled to the processor 415. Part of the memory 420 could include a RAM, and another part of the memory 420 could include a Flash memory or other ROM. The memory 420 can include persistent storage (not shown) that represents any structure(s) capable of storing and facilitating retrieval of information (such as data, program code, and/or other suitable information). For example, the storage may include data prepared for training of the AI model. The memory 420 can contain one or more components or devices supporting longer-term storage of data, such as a read only memory, hard drive, Flash memory, or optical disc.

Although FIG. 4 illustrates one example of the server 132, various changes can be made to FIG. 4. For example, various components in FIG. 4 can be combined, further subdivided, or omitted and additional components can be added according to particular needs. As a particular example, the processor 415 can be divided into multiple processors, such as one or more central processing units (CPUs), one or more graphics processing units (GPUs), one or more neural networks, and the like.

The modern wireless systems, such as those described regarding FIGS. 1-4, utilize several types of reference signals (RS) that have been defined. For example, a channel state information reference signal (CSI-RS) may be used for DL communication between a gNB and a UE, where the UE uses received CSI-RS to measure DL CSI and report those measurements to the gNB. Also, a demodulation reference signal (DMRS) may be used by a receiver (either for DL or UL communications) to estimate CSI to demodulate received data.

A time-frequency mapping function may be applied to RS such as the CSI-RS and DMRS before they are transmitted, yielding a particular RS pattern. An RS pattern may depend on parameters such as a transmit antenna port, code division multiplexing (CDM) type, and frequency hopping enablement status.

When a resource element (RE) is used to transmit an RS, the transmission overhead may increase as that RE is not used to transmit data. It may be advantageous to reduce—or even eliminate—the overhead of the RS based on the statistics of an underlying randomly-varying wireless channel. For example, if the channel is static, then an RS signaling can be (at least temporarily) disabled, assuming that a properly-designed receiver can still recover transmitted data in the absence of an RS.

5G NR supports flexibility in the selection of an RS pattern. The selection of an RS pattern may be based on the statistics of the underlying randomly-varying wireless channel. For example, the parameter dmrs-AdditionalPosition can be used to increase the number of DMRS in a given slot in high-mobility scenarios. As another example, the parameters periodicityAndOffset-p and periodicityAndOffset-sp can be used to vary the periodicity (and slot offset) of sounding reference signal (SRS). The details of the algorithm for selecting an RS pattern are typically left to the network.

The present disclosure describes an AI/ML framework and methods for reducing the overhead of the RS via a data-aided transmission in data-aided DFT-s-OFDM systems, where one or more data symbols may be leveraged to generate information about the transmitted data and/or the underlying wireless channel. As such, the present disclosure may advantageously improve the tradeoff between channel estimation accuracy and signaling overhead when using the RS.

By using an AI model (e.g., a neural network receiver) trained to implicitly estimate an underlying wireless channel from the one or more data symbols and utilize the implicit channel estimates to demodulate the data, the embodiments of the present disclosure may reduce RS signaling overhead and facilitate data-aided DFT-s-OFDM communications. The AI model may process received data and reference symbols on separate input channels. The AI model may include two components and an IDFT operation may be placed between the two components. Further, data-aided DFT-s-OFDM communications may be also facilitated by determining one or more explicit channel estimates from the one or more data symbols by a channel estimation (CE) AI model and transmitting the one or more explicit channel estimates as side information from the CE AI model to the AI model. In those instances, the AI model may be then trained to incorporate the side information for demodulating the one or more data symbols.

Methods for generating transmitted data information and channel estimates based on demodulated data symbols to facilitate data-aided DFT-s-OFDM communications and corresponding details are provided in this disclosure below.

The following documents and standards descriptions are hereby incorporated by reference into the present disclosure as if fully set forth herein:
[1] 3GPP, TS 38.211, 5G; NR; Physical channels and modulation
[2] 3GPP, TS 38.331, 5G; NR; Radio Resource Control (RRC); Protocol specification
[3] 3GPP, TS 38.321, 5G; NR; Medium Access Control (MAC); Protocol specification.

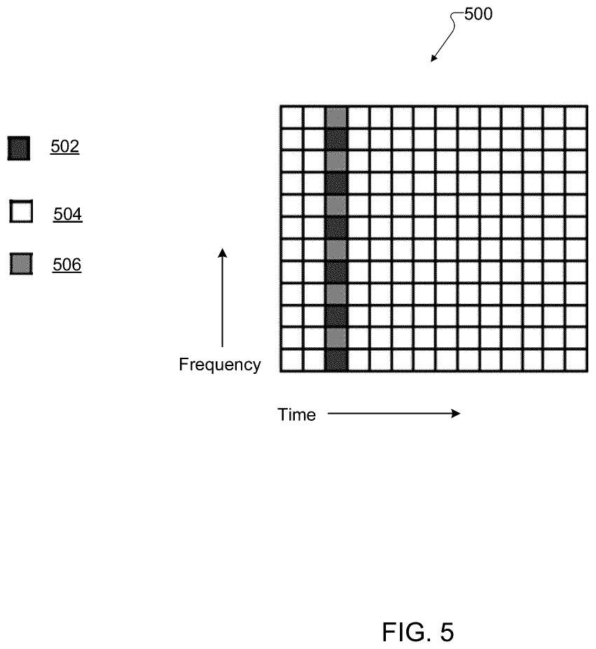

FIG. 5 illustrates an example RS pattern 500 in one transmission time interval (TTI) in DFT-s-OFDM in accordance with example embodiments of the present disclosure. The example RS pattern 500 shown in FIG. 5 is for illustration only, and the RS pattern could have similar or different configuration. However, FIG. 5 does not limit the scope of this disclosure to any particular RS pattern.

In the example RS pattern 500 as shown in FIG. 5, an RS is placed in the first REs 502 while data is placed in the second REs 504. The third REs 506 are empty. In this example physical resource block (PRB), 6 out of the 168 REs include RS (i.e. the overhead of RS is about 3.5%, while the total overhead of non-data REs is about 7%). Tracking of channel variations over frequency is facilitated by placing RS on every other RE on the third symbol.

The non-data RS overhead can be reduced in some situations.

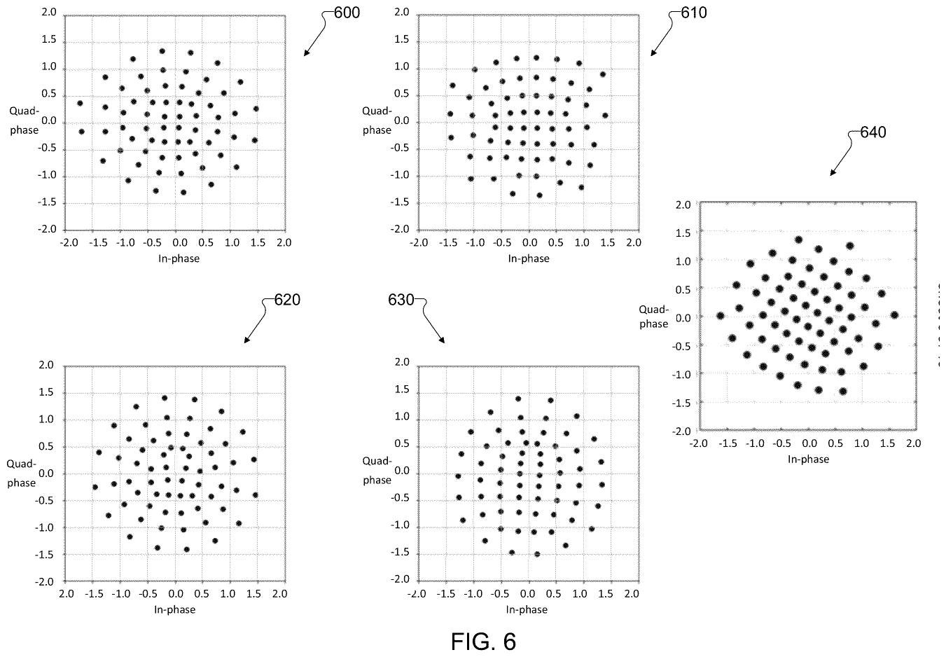

FIG. 6 illustrates example modulation constellations 600, 610, 620, 630, 640 that can be used to facilitate the RS overhead reduction in accordance with example embodiments of the present disclosure. Each of these modulation constellations 600, 610, 620, 630, 640 has been obtained via an AI/ML framework. The example modulation constellations 600, 610, 620, 630, 640 shown in FIG. 6 are for illustration only, and the modulation constellations 600, 610, 620, 630, 640 could have the same or similar configuration. However, FIG. 6 does not limit the scope of this disclosure to any particular modulation constellations.

The example constellations 600, 610, 620, 630, 640 may be more irregular than other modulation constellations such as square 64-QAM, thereby allowing them to be utilized for estimating amplitude and phase impairments. For example, rotating any of these constellations 600, 610, 620, 630, 640 through an arbitrary angle may yield a different constellation, i.e., they have no inherent phase ambiguity. In contrast, rotating a square QAM constellation through 90 degrees yields an identical constellation. Thus, data symbols from the constellations 600, 610, 620, 630, 640 can be used for channel estimation, compensation and/or demodulation. Whereas, if RSs are not transmitted and if the channel applies a phase rotation of 90 degrees or larger, data symbols from a square QAM constellation may not be demodulated.

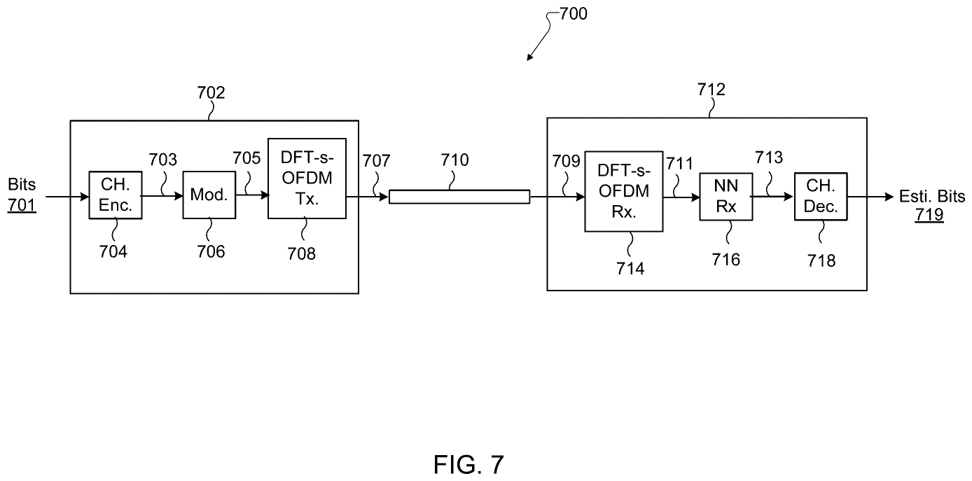

Along with the asymmetric modulation constellations, data-aided transmissions may rely on an AI/ML receiver (NN receiver or NN Rx) as illustrated in FIG. 7.

FIG. 7 illustrates an example data-aided communication system 700 in accordance with example embodiments of the present disclosure. The example data-aided communication system 700 as shown in FIG. 7 is for illustration only, and the data-aided communication system 700 could have the same or similar configuration. However, FIG. 7 does not limit the scope of this disclosure to any particular embodiment of data-aided communication systems.

As shown in FIG. 7, the system 700 may include a transmitter architecture 702, a receiver architecture 712 and a wireless channel 710 therebetween. The transmitter architecture 702 may be, e.g., a UE 111-116 of FIGS. 1 and 3. The receiver architecture 712 may be, e.g., a BS 101-103 of FIGS. 1 and 2. Either or both of the transmitter architecture 702 and the receiver architecture 712 may be AI-based. Hereinafter, the transmitter architecture 702 may also be referred to as the Tx architecture or the Tx, and the receiver architecture 712 may also be referred to as the Rx architecture or the Rx. The wireless channel 710 may be, e.g., a band channel.

The Tx architecture 702 may include a channel encoder 704, a modulator 706, and a DFT-s-OFDM transmit device (a DFT-s-OFDM Tx) 708. The channel encoder 704 may receive bits (e.g., a transport block (TB) and/or control information) 701, and perform channel coding on the bits 701 (e.g., low-density parity-check (LDPC) for data and polar for control information) to add redundancy for error correction. The encoded bits 703 may then be scrambled and input to the modulator 706.

The modulator 706 may modulate the encoded bits 703 into complex symbols using a constellation such as one of the example constellations 600, 610, 620, 630, 640 in FIG. 6. Another example of a constellation may be a uniform modulation constellation such as square QAM. Thus, the channel encoder 704 may take uncoded bits 701 and turn them into coded bits 703, which may then be modulated to constellation symbols by the modulator 706.

The DFT-s-OFDM Tx 708 may receive the modulation symbols 705 from the modulator 706 and spread the modulation symbols 705 across subcarriers to reduce PAPR. The DFT-s-OFDM Tx 708 may output the frequency-domain symbols, which may then be transformed into a time domain waveform 707 to be transmitted over the channel (also referred to herein as an underlying channel) 710.

The Rx architecture 712 may include a DFT-s-OFDM receive device (a DFT-s-OFDM Rx) 714, an AI model (e.g., a neural network receiver (NN Rx)) 716, and a channel decoder 718. The DFT-s-OFDM Rx 714 may receive the channel output 709 and perform the following operations on the channel output 709: 1) DFT; 2) subcarrier de-mapping, and 3) inverse DFT (IDFT). That is, the DFT-s-OFDM Rx 714 may convert the channel output 709 into the frequency domain, extract the subcarriers, and reverse the DFT precoding by the DFT-s-OFDM Tx 708 to recover the modulation symbols 705. The Rx architecture 712 may form input channels 711 to be fed to the NN Rx 716.

The NN Rx 716 may perform soft-demodulation on the input channels 711 and output log-likelihood ratios (LLRs) 713. The channel decoder 718 may decode the LLRs 713 to estimate the transmitted bits 701 and output the estimated bits 719. Hence, the NN Rx 716 may minimize the error between the output bits 719 from the channel decoder 718 and the input bits 701 fed to the channel encoder 704.

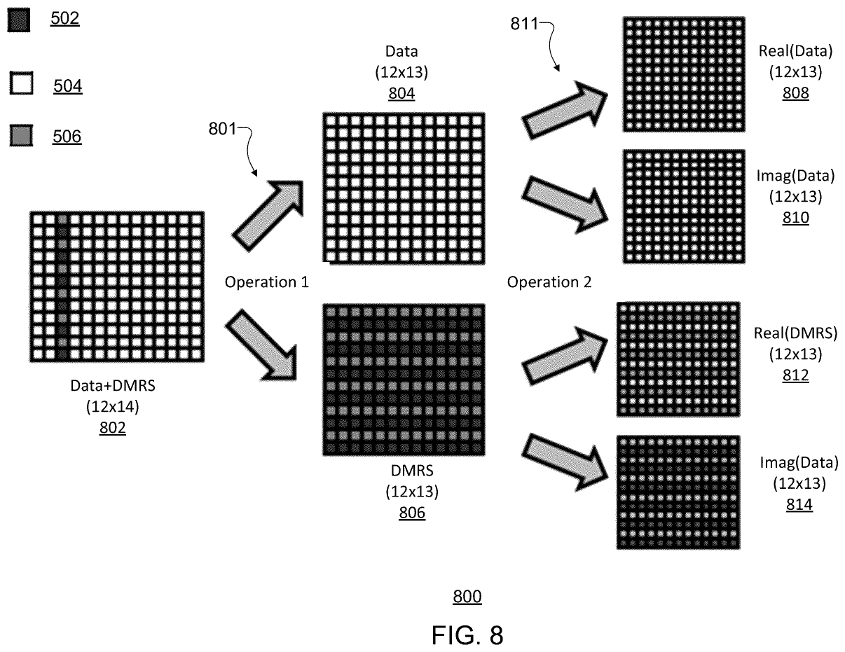

One example architecture for the NN Rx 716 may be a convolutional neural network (CNN) based architecture, where each convolutional (CONV) layer has a certain number of input and output channels. The input channels for the first CONV layer of the NN Rx 716 can be formed as illustrated in FIG. 8.

FIG. 8 illustrates an example process 800 of forming input channels to an NN Rx in data-aided DFT-s-OFDM communications in accordance with example embodiments of the present disclosure. The NN Rx may be, e.g., the NN Rx 716 of FIG. 7. The process 800 may be performed by a Rx architecture (e.g., the Rx architecture 712 of FIG. 7) or any component thereof. The example process 800 shown in FIG. 8 is for illustration only, and different channel input forming methods may be utilized to facilitate data-aided transmissions. One or more of the components illustrated in FIG. 8 may be implemented in specialized circuitry configured to perform the noted functions or one or more of the components may be implemented by one or more processors executing instructions to perform the noted functions. Other embodiments of the process of forming input channels to an NN Rx in accordance with example embodiments of the present disclosure could be used without departing from the scope of this disclosure.

As shown in FIG. 8, the DFT-s-OFDM Rx 716 may output a 12×14 time-frequency grid 802, where first REs 502 correspond to DMRS, second REs 504 correspond to data, and third REs 506 are empty, corresponding to an example of 5G NR DFT-s-OFDM transmission. Here, “12” denotes the number of subcarriers and “14” denotes the number of OFDM symbols. One DMRS may be placed on the third OFDM symbol. In this example, data and DMRS may be placed on separate real-valued input channels for the first CONV layer of the NN Rx 716.

Two sequential operations (Operation 1 801 and Operation 2 811) may be performed in order to form two real-valued input channels for the NN Rx 716.

To form the two real-valued input channels for data, the DMRS symbol may be removed in Operation 1, leaving 12×13 time-frequency grids 804, 806 for data and DMRS, respectively. The real and imaginary parts 808, 810 of these time-frequency grids 804, 806 may be then computed in Operation 2.

To form the two real-valued input channels for DMRS, the DMRS symbol may be replicated in the time domain in Operation 1, forming a 12×13 time-frequency grid 806. The real and imaginary parts 812, 814 of this time-frequency grid may be then computed in Operation 2.

The dimensions of the input channels for data and DMRS may be configured identical to enable processing by the first CONV layer.

As another example, data and DMRS can be placed on the same input channel (or channels) for the first CONV layer. For example, the real and imaginary parts of the 12×14 time-frequency output grid from the DFT-s-OFDM Rx 716 can be computed to form two real-valued input channels for the first CONV layer.

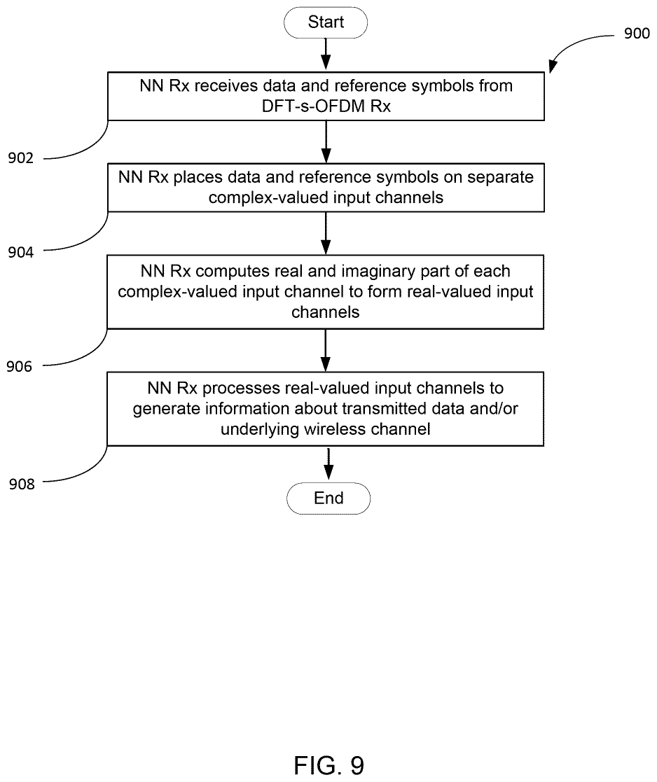

FIG. 9 illustrates an example process 900 of forming input channels to an NN Rx in data-aided DFT-s-OFDM communications in accordance with example embodiments of the present disclosure. The NN Rx may be, e.g., the NN Rx 716 of FIG. 7. The process 900 may be performed by a Rx architecture (e.g., the Rx architecture 712 of FIG. 7) or any component thereof. The embodiment of the process 900 in FIG. 9 is for illustration only. One or more of the components illustrated in FIG. 9 may be implemented in specialized circuitry configured to perform the noted functions or one or more of the components may be implemented by one or more processors executing instructions to perform the noted functions. Other embodiments of the process of forming input channels to an NN Rx in accordance with example embodiments of the present disclosure could be used without departing from the scope of this disclosure.

As shown in FIG. 9, the process 900 begins at step 902. At step 902, an NN Rx may receive data and RS from a DFT-s-OFDM Rx. At step 904, the NN Rx may place the received data and RS on separate complex-valued input channels. At step 906, the NN Rx may compute the real and imaginary parts of each complex-valued input channel to form real-valued input channels. At step 908, the NN Rx may process all of its real-valued input channels to generate information about transmitted data and/or the underlying wireless channel.

Placing the data and RS on separate real-valued input channels may facilitate the subsequent processing by an NN Rx since the NN Rx can then use the real-valued input RS channels to perform channel estimation and utilize these channel estimates to compensate the real-valued input data channels.

In one example, step 904 can be performed according to Operation 1 in FIG. 8, where the RS is removed from the received time-frequency grid (forming a complex-valued input channel for data) and then replicated in the time domain (forming a complex-valued input channel for RS).

In one example, step 906 can be performed according to Operation 2 in FIG. 8, where the real and imaginary parts of each complex-valued time-frequency grid (one for data and one for RS) are computed, yielding four real-valued time-frequency grids (two for data and two for RS).

In one example, the generated information at step 908 can include LLRs that can be passed to a channel decoder. In another example, the generated information at step 908 can include soft-demodulated symbols. In yet another example, the generated information at step 908 can include estimates of the underlying wireless channel (e.g. the complex-valued channel coefficient for one or more REs in the time-frequency grid in FIG. 8). In yet another example, the generated information at step 908 can include estimates of the transmitted bits (e.g., the bits 701 of FIG. 7).

In one example, the NN Rx in the example process 900 may include one or more layers that have been trained with a modulation constellation for data-aided communication and an error function.

In one example, step 902 can be modified to support an NN Rx receiving data and RS on the same input channel (or channels) from a DFT-s-OFDM Rx.

In one example, step 902 can be modified to support an NN Rx receiving the ground-truth RS and/or the RS configuration (or RS configurations, if multiple RS configurations are supported) as an additional input.

In the example data-aided communication system 700 of FIG. 7, the NN Rx 716 may operate in the time domain by jointly 1) estimating the underlying time-domain channel, and 2) performing time-domain equalization to remove inter-symbol interference (ISI) between data symbols. This joint estimation-equalization task may be affected by, e.g., the following factors:
ISI between data symbols, which arises from multipath propagation over a wireless channel, could degrade the quality of the estimates of the underlying wireless channel by the NN Rx (recall that the NN Rx can leverage data and/or RS symbols to perform channel estimation)
ISI could hamper time-domain equalization (which relies on estimates of the underlying wireless channel) as the number of PRBs increases (recall that the modulation symbol duration varies inversely with the number of PRBs, increasing vulnerability to the effects of frequency-selective fading).

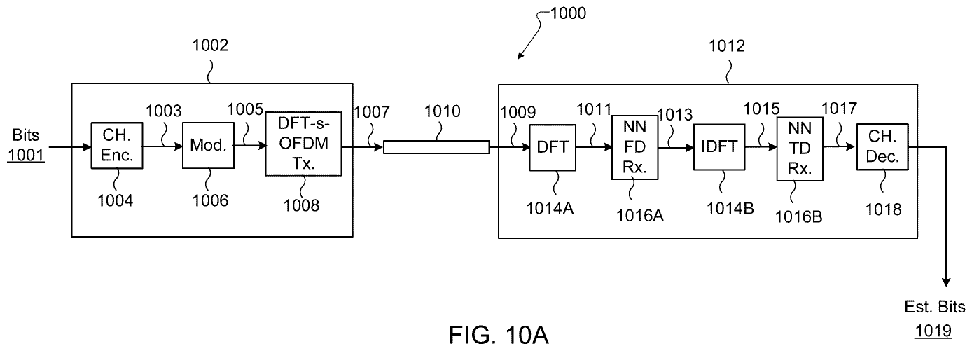

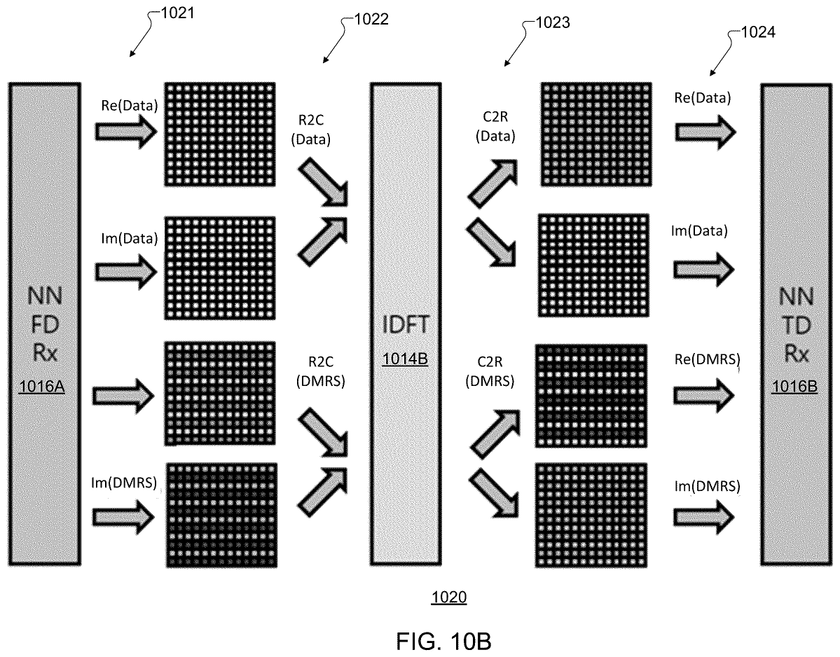

Thus, other example approaches to the joint estimation-equalization task may be provided as illustrated in FIGS. 10A-B.

FIGS. 10A-B illustrate an example process 1020 of forming input channels to an NN Rx in an example data-aided communication system 1000 in accordance with example embodiments of the present disclosure. In this example, the NN Rx may utilize a hybrid frequency-time NN Rx architecture 1016 to address issues arising with respect to the joint estimation and equalization tasks discussed in FIG. 9. The embodiments of the example system and architecture illustrated in FIGS. 10A-B are for illustration only. One or more of the components illustrated in FIGS. 10A-B may be implemented in specialized circuitry configured to perform the noted functions or one or more of the components may be implemented by one or more processors executing instructions to perform the noted functions. Other embodiments of NN Rx architectures for a data-aided communication system could be used without departing from the scope of this disclosure.

As shown in FIG. 10A, the Rx architecture 1012 may be similar to the Rx architecture 712 of FIG. 7, but differ in that the DFT-s-OFDM Rx 1014 may be split into separate “DFT” and “IDFT” blocks 1014A, 1014B and NN Rx 1016 may be split into separate NN FD Rx 1016A and NN TD Rx 1016B. The DFT block 1014A may output a frequency-domain signal 1011 that can be passed to the NN FD Rx 1016A.

In one example, the complex-valued output 1011 of the DFT block can be separated into real-valued input channels to the NN FD Rx 1016A for data and RS. For example, Operations 1 and 2 of FIG. 8 may be used to separate the complex-valued output of the DFT block into real-valued input channels for the NN FD Rx 1016A. The NN FD Rx 1016A can then split the joint estimation-equalization task into separate estimation and equalization sub-tasks.

For the first sub-task (the channel estimation sub-task), frequency-domain channel estimation algorithms can be utilized. Frequency-domain channel estimation may be inherently easier than time-domain channel estimation since it relies on the efficient matrix-based operations that are inherent to OFDM. For example, consider the time-frequency grids after Operation 2 in FIG. 8. A least-squares channel estimator could use the received DMRS (i.e., the bottom two grids 812, 814 after Operation 2 in FIG. 8), along with its knowledge of the transmitted DMRS, to obtain frequency-domain channel estimates (i.e., one estimate per RE in the time-frequency grid). Thus, the NN FD Rx 1016A could leverage both the inherent benefits of frequency-domain channel estimation and the additional degrees of freedom of NN-based processing as compared to other channel estimation algorithms.

For the second sub-task (the equalization sub-task), frequency-domain equalizers may be utilized. Frequency-domain equalization may be inherently easier than time-domain equalization since it relies on the efficient matrix-based operations that are inherent to OFDM. In OFDM systems, a frequency-domain equalizer (e.g., matched filtering, minimum mean square error (MMSE), zero-forcing (ZF)) may act as a simple “one-tap equalizer” (in contrast to multi-tap equalization in the time domain), where the single tap corresponds to the frequency-domain channel estimates. The NN FD Rx 1016A could leverage both the inherent benefits of frequency-domain equalization and the additional degrees of freedom of the NN-based processing as compared to other equalizers. Here, the NN FD Rx 1016A could utilize the output of the first sub-task to equalize the received data (i.e., the top two grids 808, 810 after Operation 2 in FIG. 8). This may simplify the NN TD Rx 1016B operations by removing at least some channel impairments.

The NN FD Rx 1016A can then pass the frequency-domain channel estimates and compensated signals 1013 to the IDFT block 1014B on separate real-valued output channels 1021, as shown in FIG. 10B. The dimensions of these real-valued output channels may match the dimensions of the output of the subcarrier de-mapping operation in the DFT-s-OFDM Rx 714 of FIG. 7. The real-valued output channels corresponding to the real and imaginary parts of a given information type (i.e., channel estimates or compensated signals) may be combined to form complex-valued channels 1022 that are processed by the IDFT block 1014B, as shown in FIG. 10B. The IDFT block 1014B may then output a complex-valued time-domain signal, which is divided 1023 into corresponding real and imaginary parts 1024, as shown in FIG. 10B. These real-valued channels 1024 may be then passed to the NN TD Rx 1016B, as shown in FIG. 10B.

The NN TD Rx 1016B may utilize the time-domain channel estimates to perform additional time-domain compensation on the compensated signals. This task may be facilitated by explicitly passing channel estimates and compensated signals to the NN TD Rx 1016B on separate channels. Thus, time-domain compensation of compensated signals may be inherently simpler in the example process 1000 than the time-domain compensation of the raw output of the DFT-s-OFDM Rx 1014 in FIG. 7.

In another example, the NN FD Rx 1016B can pass the channel estimates and the compensated signals on the same output channel (or channels) to the IDFT block 1014B.

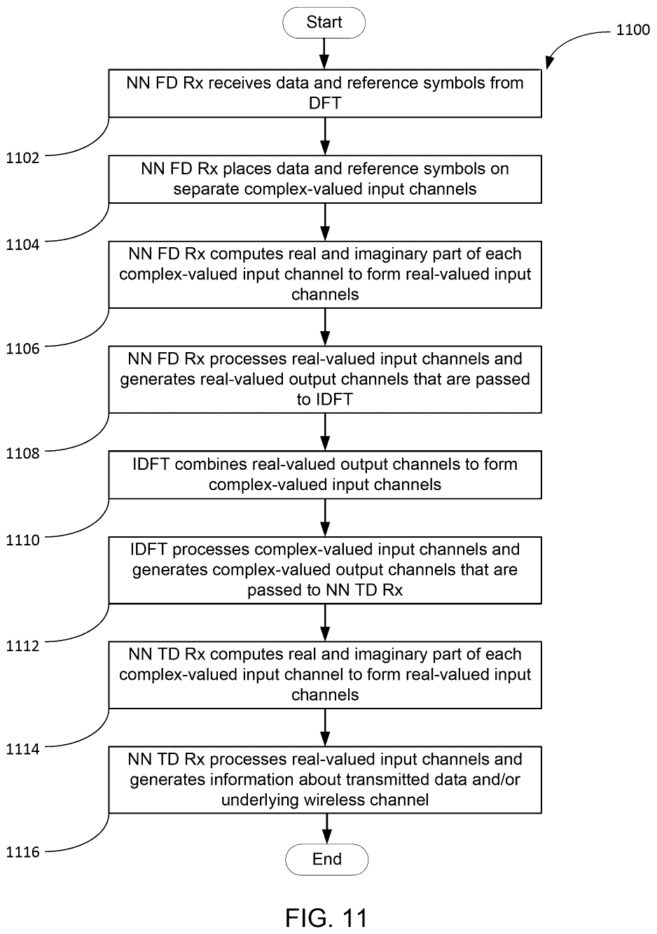

FIG. 11 illustrates an example process 1100 of data-aided communications performed by an Rx architecture in accordance with example embodiments of the present disclosure. The example process 1100 shown in FIG. 11 may be performed by the Rx architecture (e.g., an AI-based BS 712, 1012 of FIGS. 7 and 10A) or any component (e.g., the DFT-s-OFDM receiver 714, 1014A-B or the NN Rx 716, 1016A-B of FIGS. 7 and 10A) thereof. The embodiment of the process illustrated in FIG. 11 is for illustration only. One or more of the components illustrated in FIG. 11 may be implemented in specialized circuitry configured to perform the noted functions or one or more of the components may be implemented by one or more processors executing instructions to perform the noted functions. Other embodiments of the process for receive operations for data-aided communications could be used without departing from the scope of this disclosure.

As shown in the example of FIG. 11, the process 1100 begins at step 1102. At step 1102, an NN FD Rx may receive data and RS from a DFT block. At step 1104, the NN FD Rx may place the received data and RS on separate complex-valued input channels. At step 1106, the NN FD Rx may compute the real and imaginary part of each complex-valued input channel to form real-valued input channels. At step 1108, the NN FD Rx may process all of the real-valued input channels to generate real-valued output channels that can be passed to an IDFT block. At step 1110, the IDFT block may combine pairs of real-valued input channels (where each pair may correspond to real and imaginary parts) to form complex-valued input channels. At step 1112, the IDFT block may process the complex-valued input channels to generate complex-valued output channels that can be passed to an NN TD Rx. At step 1114, the NN TD Rx may compute the real and imaginary parts of each complex-valued input channel to form real-valued input channels. At step 1116, the NN TD Rx may process all of its real-valued input channels to generate information about transmitted data and/or the underlying wireless channel.

Placing data and RS on separate real-valued input channels to an NN FD Rx may facilitate frequency-domain channel estimation and frequency-domain equalization, as the NN FD Rx can then address these sub-tasks sequentially. Placing channel estimates and compensated signals on separate real-valued input channels to an NN TD Rx may facilitate time-domain equalization, as the NN TD Rx can then be trained to optimally combine the signals.

In one example, step 1104 can be performed according to Operation 1 in FIG. 8, where RS is removed from the received time-frequency grid (forming a complex-valued input channel for data) and then replicated in the time domain (forming a complex-valued input channel for RS).

In one example, step 1106 and/or step 1114 can be performed according to Operation 2 in FIG. 8, where the real and imaginary parts of each complex-valued time-frequency grid (one for data and one for RS) are computed, yielding four real-valued time-frequency grids (two for data and two for RS).

In one example, the generated information in step 1116 may include LLRs that can be passed to a channel decoder. In another example, the generated information may include soft-demodulated symbols. In yet another example, the generated information may include estimates of the underlying wireless channel (e.g., the complex-valued channel coefficient for each RE in the time-frequency grid in FIG. 8). In yet another example, the generated information may include estimates of the transmitted bits.

In one example, the NN FD Rx and/or NN TD Rx in the example process 1100 may include one or more layers that have been trained with a modulation constellation for data-aided communication and an error function.

In one example, the example process 1100 can be modified to support data and RS being passed on the same channel (or channels) between the DFT block and the NN FD Rx, between the NN FD Rx and the IDFT block, and/or between the IDFT block and the NN TD Rx.

In one example, step 1102 and/or step 1116 can be modified to support an NN FD Rx and/or an NN TD Rx receiving the ground-truth RS and/or the RS configuration (or RS configurations, if multiple RS configurations are supported) as an additional input.

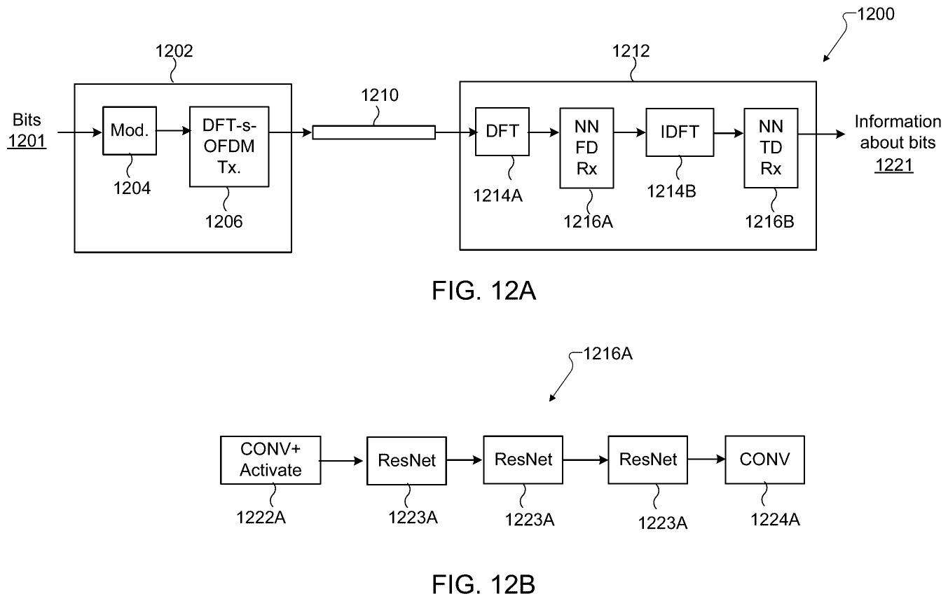

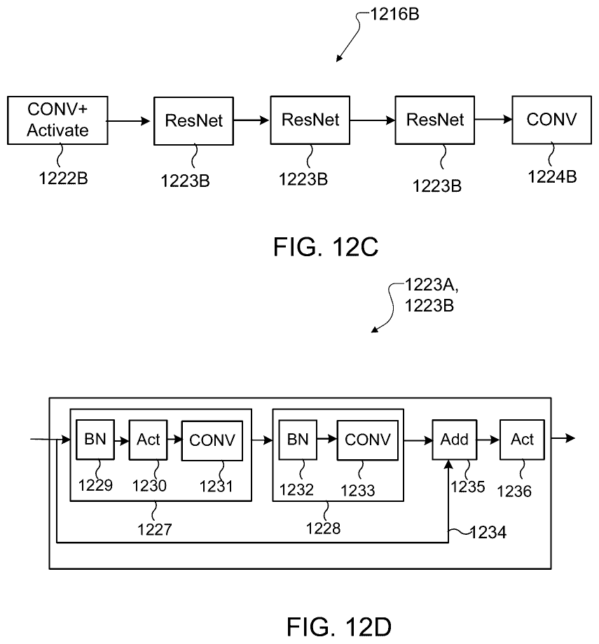

FIGS. 12A-D illustrate an example architecture of a hybrid frequency-time NN Rx 1216A, 1216B in a data-aided communication system 1200 in accordance with example embodiments of the present disclosure. The embodiments of the example architecture illustrated in FIGS. 12A-D are for illustration only. One or more of the components illustrated in FIGS. 12A-D may be implemented in specialized circuitry configured to perform the noted functions or one or more of the components may be implemented by one or more processors executing instructions to perform the noted functions. Other embodiments of NN Rx architectures for a data-aided communication system could be used without departing from the scope of this disclosure.

As illustrated in FIG. 12A, the data-aided communication system 1200 may include a Tx architecture (e.g., the Tx architecture 702 of FIG. 7) 1202 and a Rx architecture 1212. The Rx architecture 1212 may include and/or support a NN Rx that is split into an NN FD Rx 1216A and an NN TD Rx 1216B. The Tx architecture 1202 may receive uncoded bits 1201. The modulator 1204 may perform constellation modulation on the bits 1201, and a DFT-s-OFDM Tx 1206 may perform DFT-s-OFDM transmission processing on the modulated symbols. The processed OFDM symbols in the time domain may be transmitted to the Rx architecture 1212 over a channel 1210. The DFT block 1214A may apply DFT to convert the received symbols into the frequency domain symbols.

The NN FD Rx 1216A may separate data and RS on separate complex-valued input channels, compute real and imaginary components of each complex-valued input channel to generate real-valued input channels, and process the real-valued input channels to generate real-valued output channels. That is, the NN FD Rx 1216A may perform frequency-domain channel estimation and equalization sequentially on the real-valued input channels and output the real-valued output channels including the frequency-domain channel estimates and compensated signals to the IDFT block 1214B. The IDFT block 1214B may combine real-valued output channels to form complex-valued input channels on separate real and imaginary input channels. The NN TD Rx 1216B may compute real and imaginary components of each complex-valued input channel to generate real-valued input channels and process the real-valued input channels to generate information about the transmitted data 1201 and/or the underlying wireless channel 1210.

In this example architecture, the NN FD Rx 1216A and the NN TD Rx 1216B each may include an initial CONV layer followed by a nonlinear activation function, three serially-connected “ResNet” blocks (ResNet), and a final CONV layer as illustrated in FIGS. 12B-C.

FIG. 12B illustrates an example architecture of the NN FD Rx 1216A. As illustrated in FIG. 12B, the NN FD Rx 1216A may include an initial convolution (CONV) block 1222A including an initial CONV layer followed by an initial nonlinear activation function, multiple serially-connected “ResNet” blocks (ResNet) 1223A, and a final CONV layer 1224A. The initial CONV layer may perform the initial convolution (e.g., apply filters to the symbols and extract linear feature maps) on the received symbols. The output of the initial CONV layer may be passed through an activation function (e.g., an ELU, ReLU, LeakyLU and other non-linear activation function) to avoid consecutive linear operations, thus facilitating training convergence.

While FIG. 12B shows three ResNet 1223A within the NN FD Rx 1216A, this is for illustrative purposes only, and thus any other number of ResNet 1223A can be utilized for deep learning and refinement. Further, other deep learning algorithms in addition or alternative to ResNet may be utilized.

FIG. 12C illustrates an example architecture of the NN TD Rx 1216B in further detail. As shown in FIG. 12C, the NN TD Rx 1216B may have the same or similar architecture as the NN FD Rx 1216A. Thus, the NN TD Rx 1216B may include an initial CONV block 1222B including an initial CONV layer followed by an initial nonlinear activation function, multiple serially-connected ResNet 1223B, and a final CONV layer 1224B.

In this example architecture, the ResNet 1223A, 1223B may include an initial BN layer followed by a nonlinear activation function followed by a first CONV layer, a BN layer followed by a second CONV layer, the sum of the input to the initial BN layer and the output of the second CONV layer, and a nonlinear activation function as shown in FIG. 12D.

FIG. 12D illustrates an example architecture of the ResNet 1223A, 1223B. In this example, each ResNet 1223A, 1223B may include a first subblock 1227, a second subblock 1228, an addition operation 1235, and an activation function 1236. The first subblock 1227 may include a first BN layer 1229, a first activation function 1230, and a first CONV layer 1231, in that order. The nonlinear feature maps from the initial nonlinear activation function may be input to the first subblock 1227 for normalization by the first BN layer 1229, further element-wise nonlinearity refinement by the first nonlinear activation function 1230, and further convolutional filtering by the first CONV layer 1231 to extract refined linear feature maps. Note that the first nonlinear activation function 1230 may be utilized here after the batch normalization 1229 and before convolution 1231 so as to avoid issues with dead neurons.

The second subblock 1228 may include a second BN layer 1232 followed by a second CONV layer 1233. The refined nonlinear feature maps may be input to the second subblock 1228 for further refinement. The second BN layer 1232 may perform normalization and the second CONV layer 1233 may perform further convolutional filtering.

The addition operation 1235 may perform residual addition via skip connection 1234. The second nonlinear activation function 1236 may introduce nonlinearity to the combined feature maps to generate further refined nonlinear feature maps. Note that the second nonlinear activation function 1236 may also be utilized here after the batch normalization 1232 and convolution 1233 so as to avoid the issues with dead neurons.

The further refined nonlinear feature maps may be input to the next ResNet 1223A, 1223B for even further refinement until the last ResNet 1223A, 1223B has performed the last refinement. The final nonlinear feature maps output from the last ResNet 1223A, 1223B may pass through the final CONV layer 1224A,1224B. The final CONV layer 1224A, 1224B may process the final nonlinear feature maps to produce bit-wise soft decisions (e.g., LLRs for each bit position). The NN Rx 1216A, 1216B may then output information (e.g., the soft decisions) about the transmitted bits 1201 to facilitate data-aided communications.

One example of a nonlinear activation function may be an exponential linear unit (ELU) activation function as following:

$$E L U ( x ) = \{ \begin{matrix}α ( {e}^{x} - 1 ) , x < 0 \\ x , x \geq 0\end{matrix} \qquad ( 1 )$$

Here, α is a hyperparameter.

Another example of a nonlinear activation function may be a rectified linear unit (ReLU) activation function as following:

$$R e L U ( x ) = \{ \begin{matrix}0 , x < 0 \\ x , x \geq 0\end{matrix} \qquad ( 2 )$$

Yet another example of a nonlinear activation function may be a Leaky ReLU activation function as following:

$$LeakyReLU ( x ) = \{ \begin{matrix}α x , x < 0 \\ x , x \geq 0\end{matrix} \qquad ( 3 )$$

Other examples of nonlinear activation functions may include the sigmoid and/or tanh activation functions. This hybrid frequency-time NN Rx architecture can be modified to support other types of layers (e.g. Linear, LSTM).

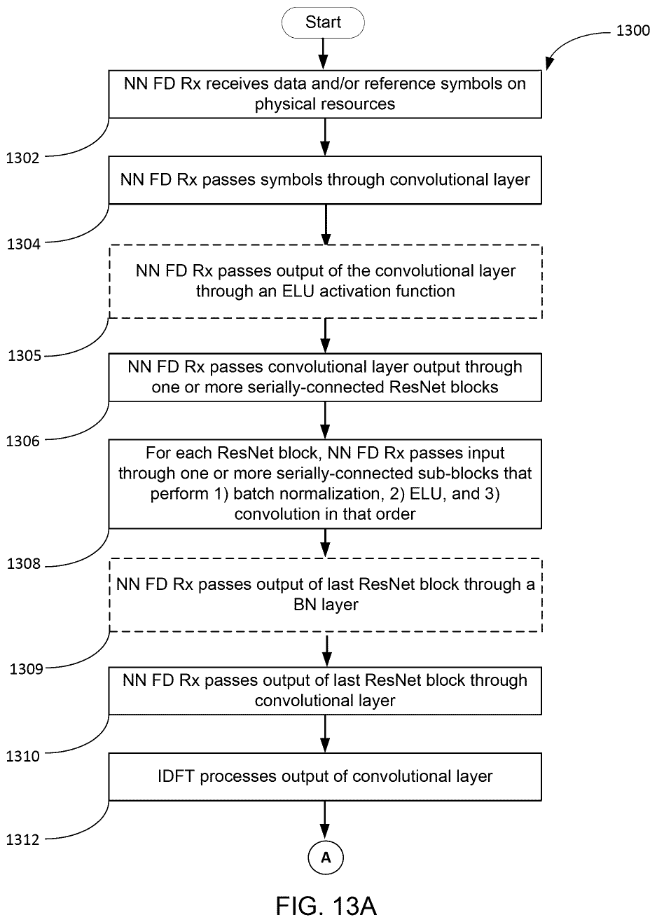

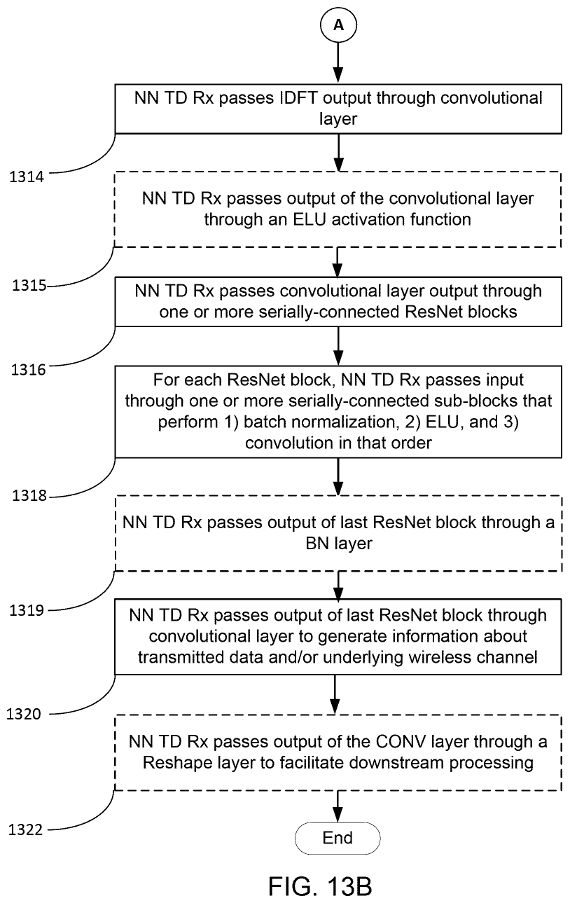

FIGS. 13A-B illustrate an example process 1300 of data-aided communications performed by an Rx architecture in accordance with example embodiments of the present disclosure. The example process 1300 shown in FIGS. 13A-B may be performed by the Rx architecture (e.g., an AI-based BS 712, 1012, 1212 of FIGS. 7, 10A and 12) or any component (e.g., the NN Rx 716, 1016A-B, 1216A-B of FIGS. 7, 10A, and 12A-C) thereof. The embodiment of the process illustrated in FIGS. 13A-B is for illustration only. One or more of the components illustrated in FIGS. 13A-B may be implemented in specialized circuitry configured to perform the noted functions or one or more of the components may be implemented by one or more processors executing instructions to perform the noted functions. Other embodiments of the process for receive operations for data-aided communications could be used without departing from the scope of this disclosure. For example, while the example process 1300 may be performed by an NN Rx including ELU activation functions, it may be performed by an NN Rx including any other nonlinear activation functions as appropriate.

As shown in the example of FIGS. 13A-B, the process 1300 begins at step 1302. At step 1302, an NN FD Rx may receive data and/or RS on physical resources. One example of physical resources may be REs in a time-frequency grid that spans one TTI. At step 1304, the NN FD Rx may pass received symbols through a CONV layer. At step 1306, the NN FD Rx may pass the output of the CONV layer through one or more serially-connected ResNet. At step 1308, each ResNet may include a BN layer, an ELU activation function, and a CONV layer, in that order. At step 1310, the NN FD Rx may pass the output of the last ResNet through a CONV layer. At step 1312, an IDFT may process the output of the CONV layer. At step 1314, an NN TD Rx may pass the IDFT output through a CONV layer. At step 1316, the NN TD Rx may pass the output of the CONV layer through one or more serially-connected ResNet. At step 1318, the NN TD Rx may pass input through each ResNet including a BN layer, an ELU activation function, and a CONV layer, in that order. At step 1320, the NN TD Rx may pass the output of the last ResNet through a CONV layer to generate information about transmitted data and/or the underlying wireless channel.

In one example, the process 1300 can support data and RS being passed on separate real-valued channels (e.g., according to the example process 800 in FIG. 8) between the DFT and the NN FD Rx, between the NN FD Rx and the IDFT, and/or between the IDFT and the NN TD Rx. In another example, the process 1300 can be modified to support data and RS being passed on the same channels between the DFT and the NN FD Rx, between the NN FD Rx and the IDFT, and/or between the IDFT and the NN TD Rx.

In one example, after step 1320, the NN TD Rx can perform an additional operation at step 1322. At step 1322, the NN TD Rx may pass the output of the CONV layer through a Reshape layer to facilitate downstream processing.

Applying ELU activation functions at steps 1308 and 1318 can address issues with dead neurons that have been observed when applying other nonlinear activation functions.

In another example, at step 1320, the NN TD Rx may pass the output of the last ResNet through a CONV layer to generate channel estimates. The number of output channels in the CONV layer can be set to “2” to correspond to the {magnitude, phase} or {real part, imaginary part} for the generated complex-valued channel estimates.

In one example, the generated information at step 1320 can include LLRs that can be passed to a channel decoder. In another example, the generated information at step 1320 can include soft-demodulated symbols. In another example, the generated information at step 1320 can include estimates of the underlying wireless channel (e.g., the complex-valued channel coefficient for REs in the time-frequency grid in FIG. 8). In another example, the generated information at step 1320 may include estimates of the transmitted bits.

In one example, between steps 1304 and 1306, the NN FD Rx can perform an additional operation at step 1305. At step 1305, the NN FD Rx can pass the output of the CONV layer through an ELU activation function.

In one example, between steps 1308 and 1310, the NN FD Rx can perform an additional operation at step 1309. At step 1309, the NN FD Rx can pass the output of the last ResNet block through a BN layer.

In one example, between steps 1314 and 1316, the NN TD Rx can perform an additional operation at step 1315. At step 1315, the NN TD Rx can pass the output of the CONV layer through an ELU activation function.

In one example, between steps 1318 and 1320, the NN TD Rx can perform an additional operation at step 1319. At step 1319, the NN TD Rx can pass the output of the last ResNet block through a BN layer.

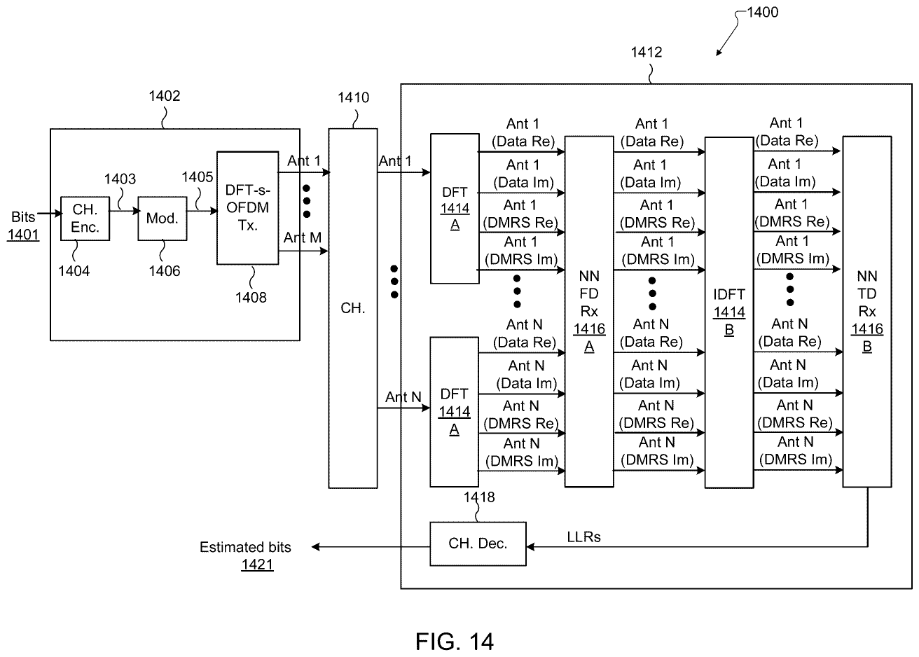

FIG. 14 illustrates an example pipeline 1400 of data-aided communications performed by an Rx architecture in accordance with example embodiments of the present disclosure. The example pipeline 1400 shown in FIG. 14 may be performed by the Rx architecture (e.g., an AI-based BS 1212 of FIGS. 10A-B) or any component (e.g., the hybrid frequency-time NN Rx such as the NN FD Rx 1016A and the NN TD Rx 1016B of FIGS. 10A-B) thereof. The embodiment of the pipeline illustrated in FIG. 14 is for illustration only. One or more of the components illustrated in FIG. 14 may be implemented in specialized circuitry configured to perform the noted functions or one or more of the components may be implemented by one or more processors executing instructions to perform the noted functions. Other embodiments of the pipeline for data-aided communications could be used without departing from the scope of this disclosure.

As shown in FIG. 14, the hybrid frequency-time NN Rx in FIGS. 10A-B can be extended to support MIMO data-aided communication. The “Channel” block 1410 may be an N×M MIMO channel 1410. A DFT block 1414A may be performed on the output of each receive antenna, and then the output of each DFT block 1414A may be divided into four input channels to the NN FD Rx 1416A. Each DFT block can create these four input channels by applying the process 800 of FIG. 8 and then taking the real and imaginary parts of the time-frequency grids for data and DMRS.

The “Data” and “DMRS” labels in FIG. 14 can be viewed as labels for processed (and channel-impaired) data and DMRS symbols. Also, while the labels on either side of the NN FD Rx 1416A and the IDFT block 1414B may be identical, the information on the corresponding input and output channels for each of those blocks may differ.

The IDFT block 1414B may operate on complex-valued signals, and so the real-valued signals on paired “Real” (Re) and “Imag” (Im) input channels for a given receive antenna and signal type (i.e., “Data” or “DMRS”) may be combined to form complex-valued signals before the signals are processed by the IDFT block 1414B.

In another example, the number of input and/or output channels in FIG. 14 can be reduced by modifying the NN FD Rx 1416A and/or the NN TD Rx 1416B to process complex-valued inputs and/or generate complex-valued outputs.

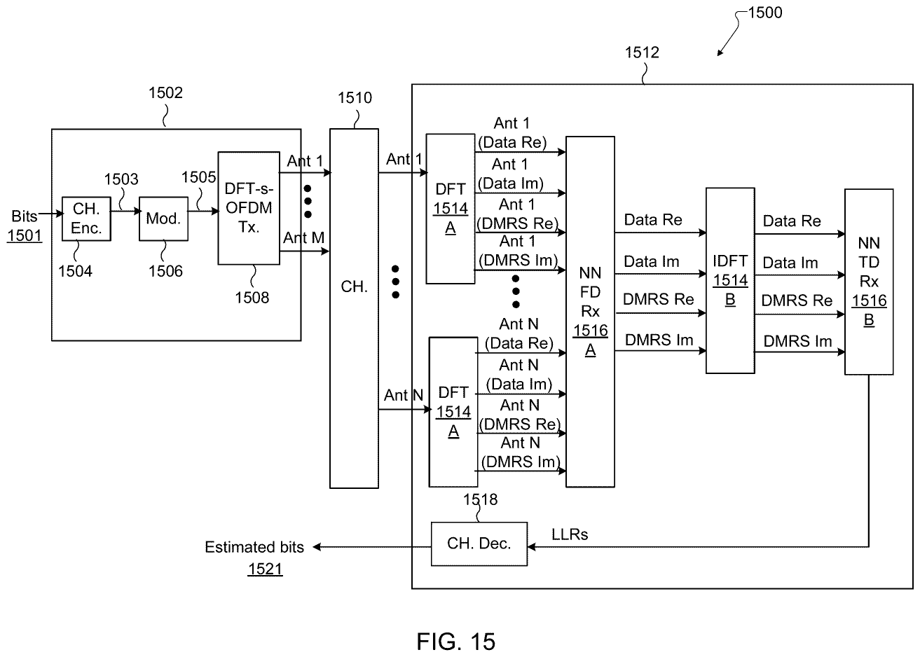

FIG. 15 illustrates an example pipeline 1500 for data-aided communications performed by an Rx architecture in accordance with example embodiments of the present disclosure. The example pipeline 1500 shown in FIG. 15 may be performed by the Rx architecture (e.g., an AI-based BS 1212 of FIGS. 10A-B) or any component (e.g., the hybrid frequency-time NN Rx such as the NN FD Rx 1016A and the NN TD Rx 1016B of FIGS. 10A-B) thereof. The embodiment of the pipeline illustrated in FIG. 15 is for illustration only. One or more of the components illustrated in FIG. 15 may be implemented in specialized circuitry configured to perform the noted functions or one or more of the components may be implemented by one or more processors executing instructions to perform the noted functions. Other embodiments of the pipeline for data-aided communications could be used without departing from the scope of this disclosure.

In the example pipeline shown in FIG. 14, the number of input channels to the NN FD Rx 1416A may be equal to the number of output channels therefrom. The number of output channels can be reduced by applying the approach as shown in FIG. 15 where the NN FD Rx 1516A may have four output channels. The NN FD Rx 1516A may generate two real-valued output channels for each signal type (i.e., “Data” or “DMRS”), effectively combining the outputs from the N receive antennas.

This approach can be used to manage implementation complexity as the number of receive antennas N increases.

In another example, the number of input and/or output channels in FIG. 15 can be reduced by modifying the NN FD Rx 1516A and/or the NN TD Rx 1516B to process complex-valued inputs and/or generate complex-valued outputs.

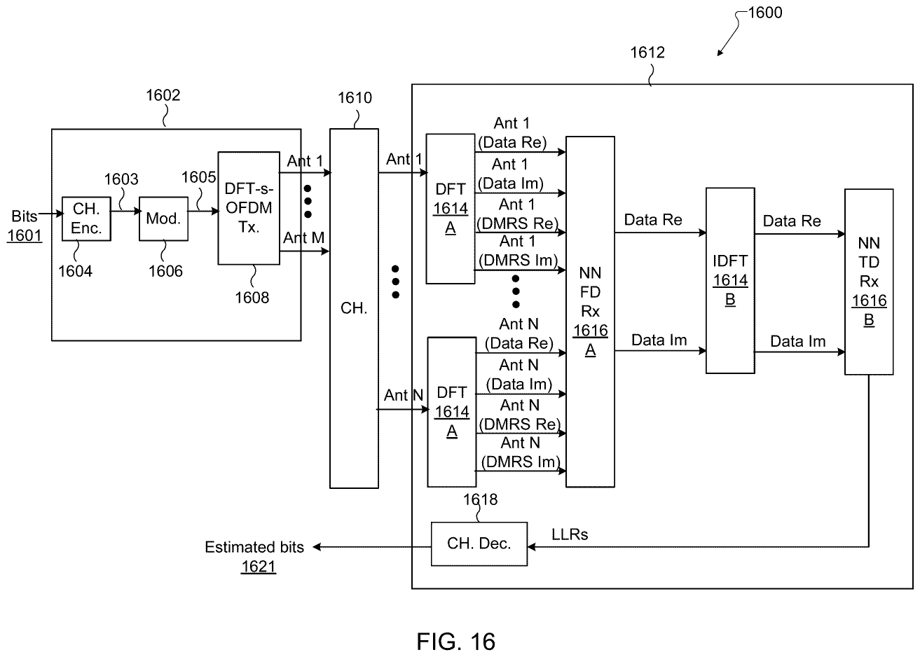

FIG. 16 illustrates an example pipeline 1600 for data-aided communications performed by an Rx architecture in accordance with example embodiments of the present disclosure. The example pipeline 1600 shown in FIG. 16 may be performed by the Rx architecture (e.g., an AI-based BS 1212 of FIGS. 10A-B) or any component (e.g., the hybrid frequency-time NN Rx such as the NN FD Rx 1016A and the NN TD Rx 1016B of FIGS. 10A-B) thereof. The embodiment of the pipeline illustrated in FIG. 16 is for illustration only. One or more of the components illustrated in FIG. 16 may be implemented in specialized circuitry configured to perform the noted functions or one or more of the components may be implemented by one or more processors executing instructions to perform the noted functions. Other embodiments of the pipeline for data-aided communications could be used without departing from the scope of this disclosure.

The number of output channels of the NN FD Rx 1516A shown in FIG. 15 can be further reduced by applying the approach as shown in FIG. 16 where the NN FD Rx 1616A may have two output channels. The NN FD Rx 1616A may essentially utilize the processed DMRS signal to apply channel compensation to the processed data signal.

This approach can be used to further reduce the implementation complexity of the downstream NN TD Rx 1616B, as the NN TD Rx 1616B may now receive a compensated data signal.

In another example, the number of input and/or output channels in FIG. 16 can be reduced by modifying the NN FD Rx 1616A and/or the NN TD Rx 1616B to process complex-valued inputs and/or generate complex-valued outputs.

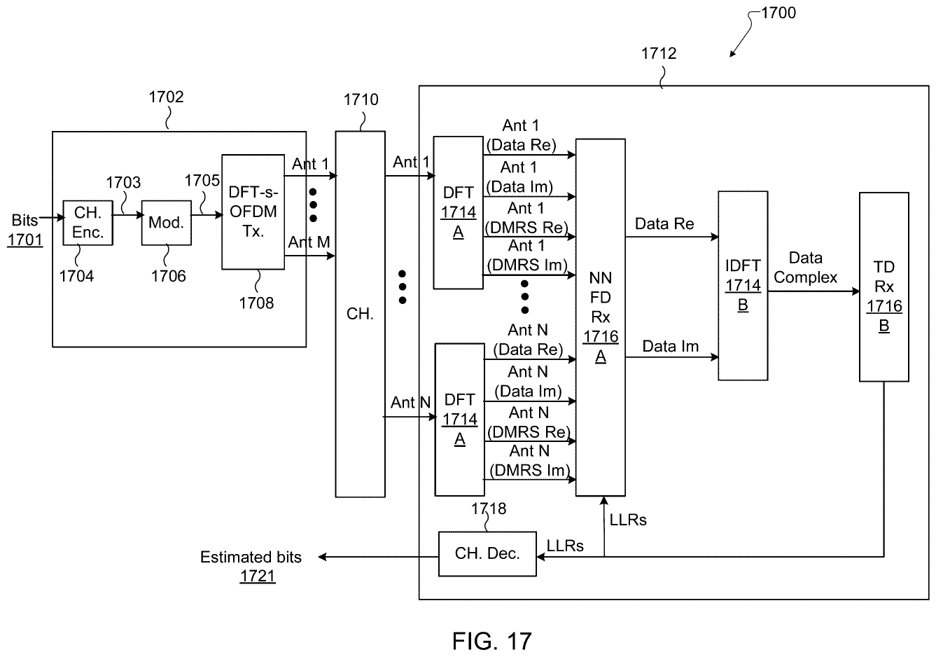

FIG. 17 illustrates an example pipeline 1700 for data-aided communications performed by an Rx architecture in accordance with example embodiments of the present disclosure. The example pipeline 1700 shown in FIG. 17 may be performed by the Rx architecture (e.g., an AI-based BS 1212 of FIGS. 10A-B) or any component (e.g., the hybrid frequency-time NN Rx such as the NN FD Rx 1016A and the NN TD Rx 1016B of FIGS. 10A-B) thereof. The embodiment of the pipeline illustrated in FIG. 17 is for illustration only. One or more of the components illustrated in FIG. 17 may be implemented in specialized circuitry configured to perform the noted functions or one or more of the components may be implemented by one or more processors executing instructions to perform the noted functions. Other embodiments of the pipeline for data-aided communications could be used without departing from the scope of this disclosure.

The approach shown in FIG. 16 can be modified as shown in FIG. 17 where the NN TD Rx may be replaced with a TD receiver (e.g., a decision feedback equalizer (DFE)) 1716B. This TD Rx 1716B may generate LLRs that can also be passed back to the NN FD Rx 1716A as a side information. In this case, the NN FD Rx 1716A (and, by extension, the IDFT block 1714B and the TD Rx 1716B) can perform multiple iterations for a given TTI, where the NN FD Rx 1716A may utilize the LLRs from previous iterations to progressively refine its outputs to the IDFT block 1714B.

This approach may be analogous to iterative decoding where message passing over multiple iterations progressively refines soft information outputs.

The NN FD Rx 1716A can combine the LLRs with the input channels from the DFT blocks 1714A, since each received symbol on those input channels corresponds to a transmit symbol from a constellation with modulation order m. The NN FD Rx 1716A can match each received symbol to the corresponding set of m LLRs.

In another example, the number of input and/or output channels in FIG. 17 can be reduced by modifying the NN FD Rx 1716A to process complex-valued inputs and/or generate complex-valued outputs.

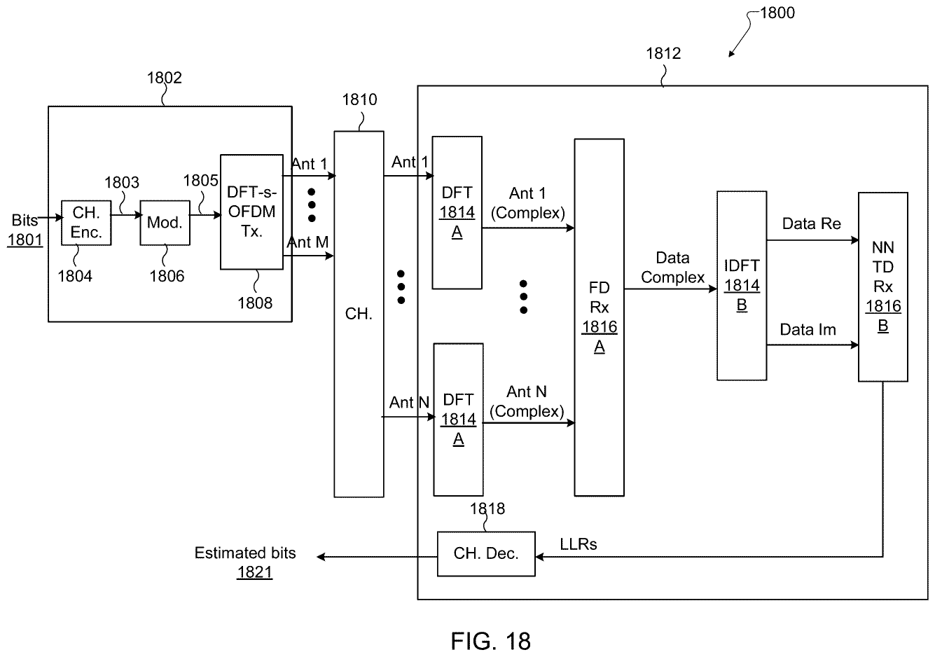

FIG. 18 illustrates an example pipeline 1800 for data-aided communications performed by an Rx architecture in accordance with example embodiments of the present disclosure. The example pipeline 1800 shown in FIG. 18 may be performed by the Rx architecture (e.g., an AI-based BS 1012 of FIGS. 10A-B) or any component (e.g., the hybrid frequency-time NN Rx such as the NN FD Rx 1016A and the NN TD Rx 1016B of FIGS. 10A-B) thereof. The embodiment of the pipeline illustrated in FIG. 18 is for illustration only. One or more of the components illustrated in FIG. 18 may be implemented in specialized circuitry configured to perform the noted functions or one or more of the components may be implemented by one or more processors executing instructions to perform the noted functions. Other embodiments of the pipeline for data-aided communications could be used without departing from the scope of this disclosure.

The approach shown in FIG. 16 can also be modified as shown in FIG. 18 where the NN FD Rx may be replaced with an FD Rx (e.g., a MIMO MMSE receiver) 1816A. This FD Rx 1816A may operate on complex-valued signals, and thus can directly receive the output of each DFT block 1814A without any intermediate processing. By performing frequency-domain channel estimation and compensation, the FD Rx 1816A can reduce the implementation complexity of the NN TD Rx 1816B.

In another example, the number of input channels to the NN TD Rx 1816B can be reduced by modifying the NN TD Rx 1816B to process complex-valued inputs.

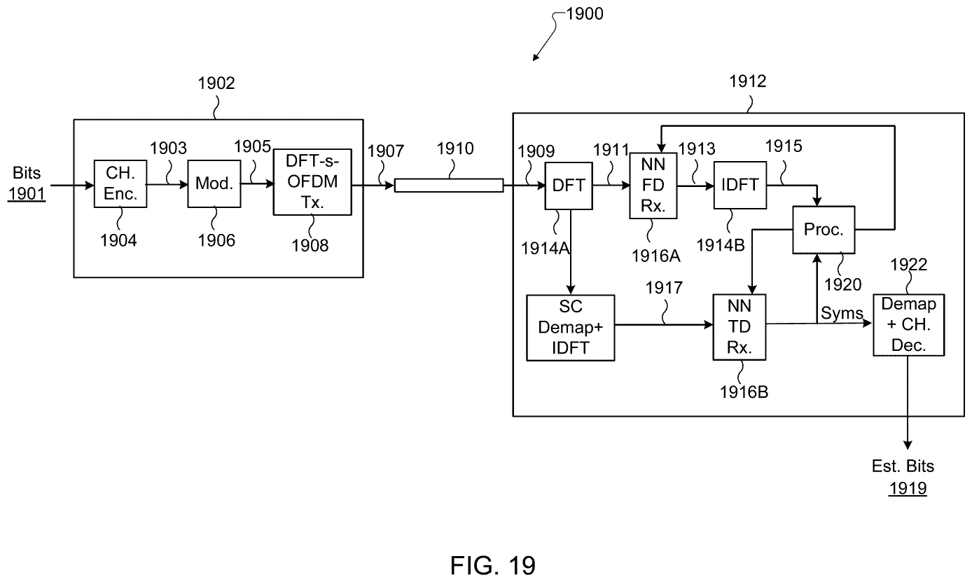

FIG. 19 illustrates an example pipeline 1900 for data-aided communications performed by an Rx architecture in accordance with example embodiments of the present disclosure. The example pipeline 1900 shown in FIG. 19 may be performed by the Rx architecture (e.g., an AI-based BS 1012 of FIGS. 10A-B) or any component (e.g., the hybrid frequency-time NN Rx such as the NN FD Rx 1016A and the NN TD Rx 1016B of FIGS. 10A-B) thereof. The embodiment of the pipeline illustrated in FIG. 19 is for illustration only. One or more of the components illustrated in FIG. 19 may be implemented in specialized circuitry configured to perform the noted functions or one or more of the components may be implemented by one or more processors executing instructions to perform the noted functions. Other embodiments of the pipeline for data-aided communications could be used without departing from the scope of this disclosure.

The hybrid frequency-time NN Rx in FIGS. 10A-B can be modified to incorporate a feedback loop as shown in FIG. 19. In this case, the NN FD Rx 1916A and the NN TD Rx 1916B may separately process the output of the DFT block 1914A in the frequency and time domains, respectively. The outputs of those blocks 1916A, 1916B may be then combined in the time domain at a “Processor” block 1920, and the output of the Processor block 1920 may be passed back to the NN FD Rx 1916A and the NN TD Rx 1916B as a side information. After multiple processing iterations, the output of the NN TD Rx 1916B may be passed to the “Demap+Channel Decoding” block 1922. This feedback loop can be designed to align the outputs of the NN FD Rx 1916A and the NN TD Rx 1916B.

In one example, the NN FD Rx 1916A and the NN TD Rx 1916B can be trained to jointly produce outputs that are similar to those of the modulator 1906.

One example of the Processor block 1920 may be an operation that computes the absolute value of the difference between the outputs of the NN FD Rx 1916A and the NN TD Rx 1916B. Another example of the Processor block 1920 may be an operation that computes the square of the absolute value of the difference between the outputs of the NN FD Rx 1916A and the NN TD Rx 1916B. Another example of the Processor block 1920 may be an operation that computes the maximum value of the square of the absolute value of the difference between the outputs of the NN FD Rx 1916A and the NN TD Rx 1916B.

In another example, the approach in FIG. 19 can be modified to combine the outputs of the NN FD Rx 1916A and the NN TD Rx 1916B in the frequency domain at the Processor block 1920. In that case, the IDFT block 1914B could be removed, and another DFT block could be placed between the output of the NN TD Rx 1916B and the input to the Processor block 1920.

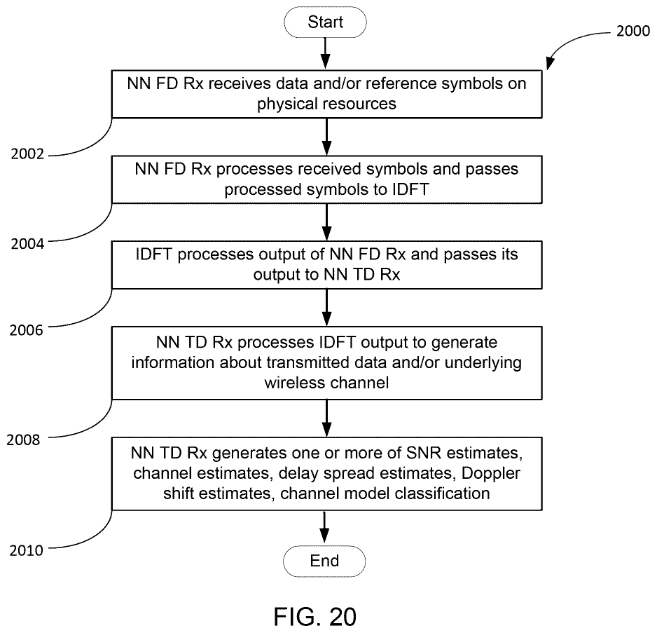

FIG. 20 illustrates an example process 2000 of data-aided communications performed by an Rx architecture in accordance with example embodiments of the present disclosure. The example process 2000 shown in FIG. 20 may be performed by the Rx architecture (e.g., an AI-based BS 1012, 1212 of FIGS. 10A and 12) or any component (e.g., the NN Rx 1016A-B, 1216A-B of FIGS. 10A, and 12A-C) thereof to support a hybrid frequency-time NN Rx that generates supplemental information. The embodiment of the process illustrated in FIG. 20 is for illustration only. One or more of the components illustrated in FIG. 20 may be implemented in specialized circuitry configured to perform the noted functions or one or more of the components may be implemented by one or more processors executing instructions to perform the noted functions. Other embodiments of the process for data-aided communications could be used without departing from the scope of this disclosure.

As shown in the example of FIG. 20, the process 2000 begins at step 2002. At step 2002, an NN FD Rx may receive data and/or RS on physical resources. One example of physical resources may be REs in a time-frequency grid that spans one TTI. At step 2004, the NN FD Rx may process the received data and RS and pass the processed symbols to an IDFT block. At step 2006, the IDFT block may process the output from the NN FD Rx and pass the processed symbols to an NN TD Rx. At step 2008, the NN TD Rx may process the output from an IDFT to generate information about the transmitted data and/or the underlying wireless channel. At step 2010, the NN TD Rx may utilize the received data and/or RS to generate one or more of SNR estimates, channel estimates, delay spread estimates, Doppler shift estimates, and channel model classification.

In one example, the method 2000 can support data and RS being passed on separate real-valued channels (e.g., according to the process 800 in FIG. 8) between the DFT block and the NN FD Rx, between the NN FD Rx and the IDFT block, and/or between the IDFT block and the NN TD Rx. In another example, the method 2000 can be modified to support data and RS being passed on the same channels between the DFT block and the NN FD Rx, between the NN FD Rx and the IDFT block, and/or between the IDFT block and the NN TD Rx.

In one example, the generated information in step 2010 may include LLRs that can be passed to a channel decoder. In another example, the generated information may include soft-demodulated symbols. In another example, the generated information may include estimates of the underlying wireless channel (e.g., the complex-valued channel coefficient for REs in the time-frequency grid of FIG. 8). In another example, the generated information may include estimates of the transmitted bits.

In one example, the NN FD Rx and/or the NN TD Rx in the method 2000 may include one or more layers that have been trained with a modulation constellation for data-aided communication and an error function.

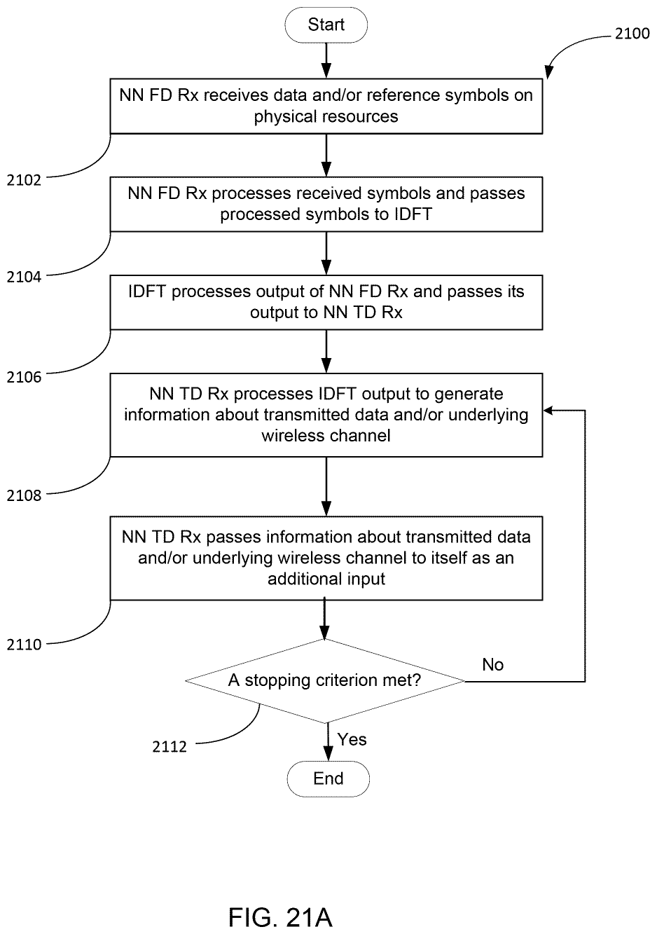

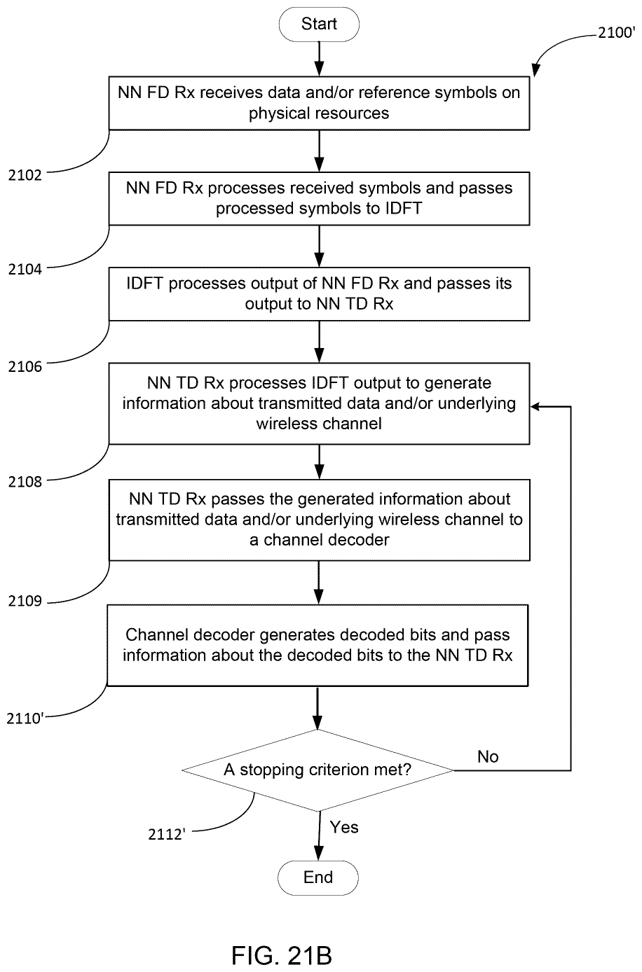

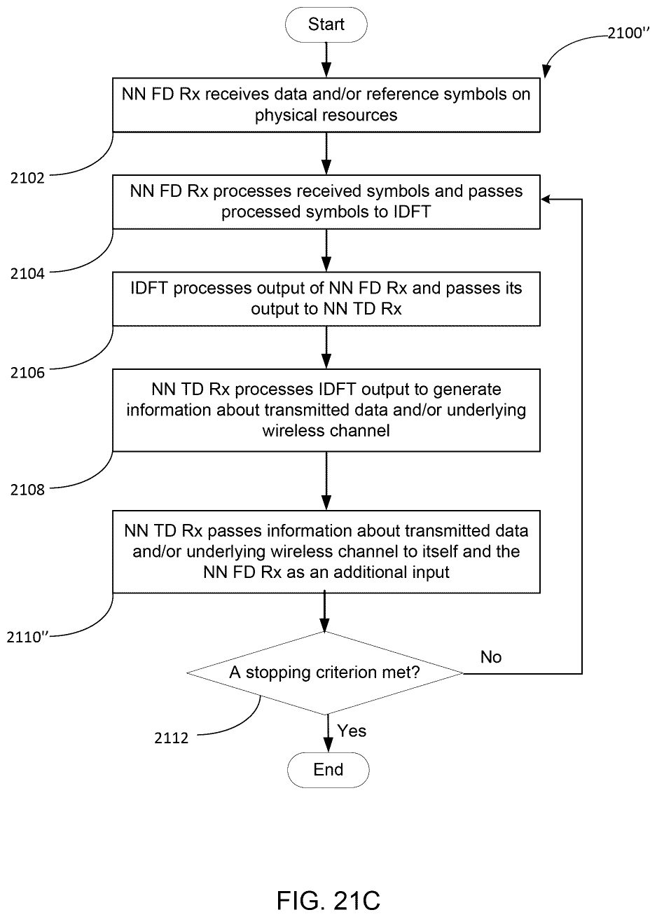

FIGS. 21A-C illustrate example processes 2100, 2100′, 2100″ of data-aided communications performed by an Rx architecture in accordance with example embodiments of the present disclosure. The example processes 2100, 2100′,2100″ shown in FIGS. 21A-C may be performed by the Rx architecture (e.g., an AI-based BS 1012, 1212 of FIGS. 10A and 12) or any component (e.g., the NN Rx 1016A-B, 1216A-B of FIGS. 10A, and 12A-C) thereof to support a hybrid frequency-time NN Rx that performs iterative processing. The embodiments of the processes illustrated in FIGS. 21A-C are for illustration only. One or more of the components illustrated in FIGS. 21A-C may be implemented in specialized circuitry configured to perform the noted functions or one or more of the components may be implemented by one or more processors executing instructions to perform the noted functions. Other embodiments of the process for data-aided communications could be used without departing from the scope of this disclosure.

As shown in the example of FIG. 21A, the process 2100 begins at step 2102. At step 2102, an NN FD Rx receives data and/or RS on physical resources. One example of physical resources may be REs in a time-frequency grid that spans one TTI. At step 2104, the NN FD Rx may process the received data and RS and pass the processed symbols to an IDFT block. At step 2106, the IDFT block may process the output from the NN FD Rx and pass the processed symbols to an NN TD Rx. At step 2108, the NN TD Rx may process the output from the IDFT block to generate information about the transmitted data and/or the underlying wireless channel. At step 2110, the NN TD Rx may utilize the generated information about the transmitted data and/or the underlying wireless channel as an additional input for another processing iteration that corresponds to step 2108. At step 2112, the Rx architecture may determine if a stopping criterion has been met. If yes, the method 2100 may end. If not, the method 2100 may return to step 2108 and the NN TD Rx may repeat steps 2108 and 2110 until a stopping criterion is achieved.

In one example, the method 2100 can support data and RS being passed on separate real-valued channels (e.g., according to the example process 800 in FIG. 8) between the DFT block and the NN FD Rx, between the NN FD Rx and the IDFT block, and/or between the IDFT block and the NN TD Rx. In another example, the method 2100 can be modified to support data and RS being passed on the same channels between the DFT block and the NN FD Rx, between the NN FD Rx and the IDFT block, and/or between the IDFT block and the NN TD Rx.

In the example process 2100′ as illustrated in FIG. 21B, between steps 2108 and 2110, the Rx architecture may perform an additional operation at step 2109. At step 2109, the NN TD Rx can pass the generated information about the transmitted data and/or the underlying wireless channel to a channel decoder. In this case, step 2110 can be modified (as step 2110′) to have a channel decoder generate decoded bits and pass information about the decoded bits to the NN TD Rx. In this case, step 2112 can be modified (as step 2112′) to have the NN TD Rx repeat steps 2108, 2109 and 2110′ until a stopping criterion is achieved.

One example of the stopping criterion in step 2112 may be the maximum absolute value of the difference between output LLRs over consecutive iterations decreasing below a threshold. Another example of the stopping criterion in step 2112 may be the number of iterations reaching a threshold. Another example of the stopping criterion in step 2112 may be a channel decoder reporting that the CRC has passed and/or the decoding operation has succeeded.

In one example, the generated information in step 2108 may include LLRs that can be passed to a channel decoder. In another example, the generated information in step 2108 may include soft-demodulated symbols. In another example, the generated information in step 2108 may include estimates of the underlying wireless channel (e.g., the complex-valued channel coefficient for REs in the time-frequency grid of FIG. 8). In another example, the generated information in step 2108 may include estimates of the transmitted bits.

In one example, the NN FD Rx and/or the NN TD Rx in the methods 2100, 2100′ may include one or more layers that have been trained with a modulation constellation for data-aided communication and an error function.

In the example process 2100″ as illustrated in FIG. 21C, step 2110 can be modified (step 2110″) such that the NN TD Rx can also pass the generated information about the transmitted data and/or the underlying wireless channel to the NN FD Rx as an additional input for another processing iteration that corresponds to step 2104. In this case, step 2112 can be modified to repeat steps 2104, 2106, 2108 and 2110″ until a stopping criterion is achieved.

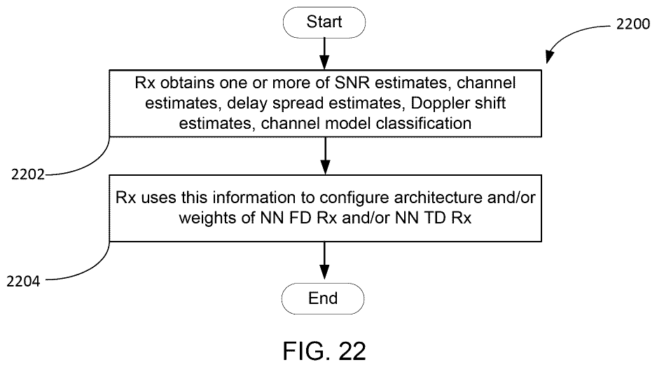

FIG. 22 illustrates an example process 2200 of data-aided communications performed by an Rx architecture in accordance with example embodiments of the present disclosure. The example process 2200 shown in FIG. 22 may be performed by the Rx architecture (e.g., an AI-based BS 1012, 1212 of FIGS. 10A and 12) or any component (e.g., the NN Rx 1016A-B, 1216A-B of FIGS. 10A, and 12A-C) thereof to support configuration of a hybrid frequency-time NN Rx for data-aided communications. The embodiment of the process illustrated in FIG. 22 is for illustration only. One or more of the components illustrated in FIG. 22 may be implemented in specialized circuitry configured to perform the noted functions or one or more of the components may be implemented by one or more processors executing instructions to perform the noted functions. Other embodiments of the process for data-aided communications could be used without departing from the scope of this disclosure.

As shown in the example of FIG. 22, the process 2200 begins at step 2202. At step 2202, an Rx architecture may obtain one or more of SNR estimates, estimates of the underlying wireless channel (e.g., the complex-valued channel coefficient for REs in the time-frequency grid of FIG. 8), delay spread estimates, Doppler shift estimates, and channel model classification. At step 2204, the Rx may utilize this information to configure the architecture and/or weights of an NN FD Rx and/or an NN TD Rx.

In one example, at step 2202 the Rx may obtain this information from a non-AI/ML based method. In another example, at step 2202 the Rx may obtain this information from an AI/ML-based method.

In one example, the NN FD Rx and/or the NN TD Rx in step 2204 may include one or more layers that have been trained with a modulation constellation for data-aided communication and an error function.

In one example, at step 2204 the Rx could determine whether data and DMRS could be passed on separate input and/or output channels to and/or from the NN FD Rx and/or the NN TD Rx.

Tables 1 and 2 below show example hybrid frequency-time NN Rx architectures for data-aided communication. The number of ResNet blocks can be set to, e.g., four with each ResNet block including two serially-connected sub-blocks in the form of (a BN layer+an ELU activation function+a CONV layer) and (a BN layer+an ELU activation function+a CONV layer+an add block), respectively.

TABLE 1
Example NN FD Rx Architecture for Data-aided Communication

| Layers | Output Dimensions |
|---|---|
| Input | 4 × 120 × 14 |
| CONV | 256 × 120 × 14 |
| (BN + ELU + CONV) + | 256 × 120 × 14 |
| (BN + ELU + CONV + add) | |
| (BN + ELU + CONV) + | 256 × 120 × 14 |
| (BN + ELU + CONV + add) | |
| (BN + ELU + CONV) + | 256 × 120 × 14 |
| (BN + ELU + CONV + add) | |
| (BN + ELU + CONV) + | 256 × 120 × 14 |
| (BN + ELU + CONV + add) | |
| CONV | 4 × 120 × 14 |

TABLE 2
Example NN TD Rx Architecture for Data-aided Communication

| Layers | Output Dimensions |
|---|---|
| Input | 4 × 120 × 14 |
| CONV | 128 × 120 × 14 |
| (BN + ELU + CONV) + | 128 × 120 × 14 |
| (BN + ELU + CONV + add) | |
| (BN + ELU + CONV) + | 128 × 120 × 14 |
| (BN + ELU + CONV + add) | |
| (BN + ELU + CONV) + | 128 × 120 × 14 |
| (BN + ELU + CONV + add) | |
| (BN + ELU + CONV) + | 128 × 120 × 14 |
| (BN + ELU + CONV + add) | |
| CONV | 6 × 120 × 14 |
| Reshape | 1680 × 6 |

It has been shown that where a hybrid frequency-time NN Rx for data was trained for a 2×1 SIMO (single-input multiple-output) system over a 3GPP TDL-A channel model with an root mean square (RMS) delay spread of 300 ns, the uncoded BER performance of this NN Rx may be within 0.7 dB of an ideal receiver that utilizes perfect CSI for BER=0.05. Also, the inference performance of this NN Rx over additive white Gaussian noise (AWGN) and a 3GPP TDL-A channel model with an RMS delay spread of 100 ns may be reasonable, highlighting its generalizability. It has also been shown that where a hybrid frequency-time NN Rx receiver was trained for a SISO (single-input single-output) system over a 3GPP TDL-A channel model with an RMS delay spread of 300 ns, this NN Rx may be utilized for inference over a 3GPP TDL-A channel model with an RMS delay spread of 300 ns. In this case, this NN Rx may outperform an ideal receiver that utilizes perfect CSI by 0.5-1 dB. When this NN Rx is utilized for inference over a 3GPP TDL-A channel model with an RMS delay spread of 100 ns, the NN Rx's uncoded BER performance may be within 0.7 dB of an ideal receiver that utilizes perfect CSI, again highlighting its generalizability. It has also been shown that where a hybrid frequency-time NN Rx was trained for a SISO system over a 3GPP TDL-A channel model with an RMS delay spread of 100 ns and utilized for inference over a 3GPP TDL-A channel model with an RMS delay spread of 100 ns, the uncoded BER performance of this NN Rx may be within 0.7 dB of an ideal receiver that utilizes perfect CSI. When this NN Rx is utilized for inference over a 3GPP TDL-A channel model with an RMS delay spread of 300 ns, the NN Rx may outperform an ideal receiver that utilizes perfect CSI by 0.2-0.6 dB, again highlighting its generalizability.

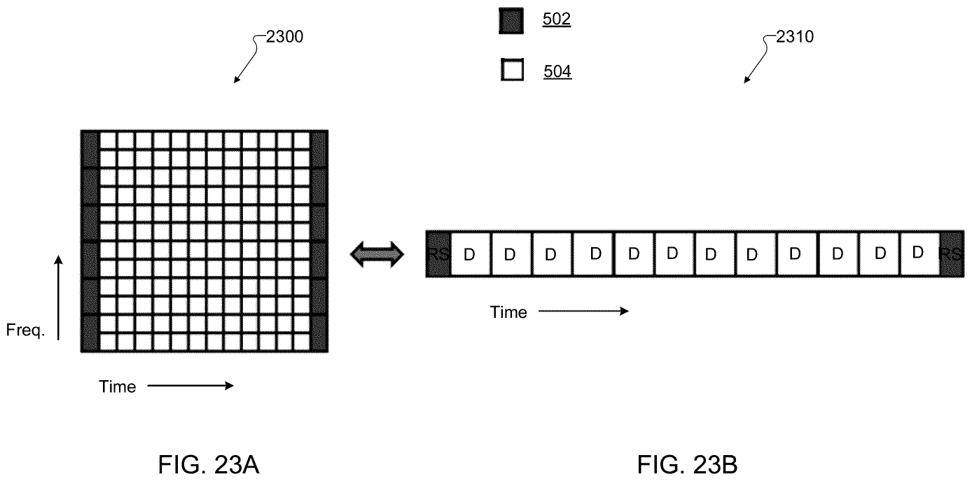

In one embodiment, the time-domain overhead of RS in data-aided transmission can also be reduced by configuring the subcarrier spacing for the RS as illustrated in FIGS. 23A-B.

FIGS. 23A-B illustrate an example subcarrier spacing configuration for a data-aided transmission in accordance with example embodiments of the present disclosure. The embodiment of the example subcarrier spacing configuration may be performed at a network device (e.g., a BS 101-103 of FIGS. 1 and 2) or any component thereof to reduce the overhead (e.g., TD overhead) of the RS in a data-aided communication system. The embodiment of the example subcarrier spacing configuration illustrated in FIGS. 23A-B is for illustration only. Other embodiments of example subcarrier spacing configuration could be used without departing from the scope of this disclosure.

As illustrated in FIGS. 23A-B, RS may be placed on the first and last OFDM symbols 502 in a TTI. In the time-frequency grid 2300 of FIG. 23A, the subcarrier spacing of the RS may be twice the subcarrier spacing of data (i.e., the REs 504). As shown in FIG. 23B, the time-frequency grid 2300 may be equivalent to the time-domain signal 2310, where the duration (i.e., the time-domain overhead) of each RS may be one half of the duration of each data symbol.

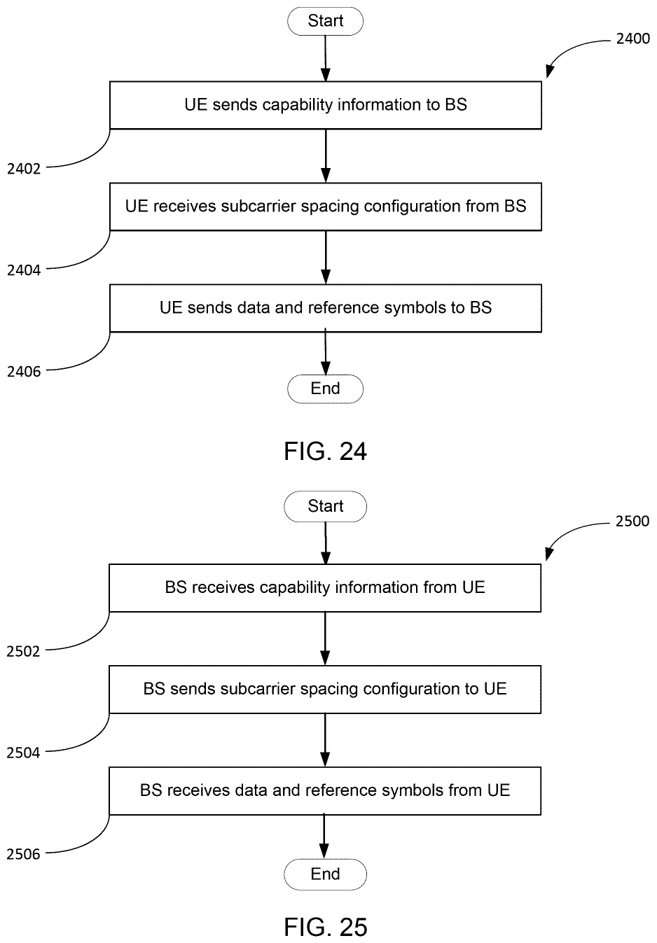

FIG. 24 illustrates an example method 2400 of supporting a subcarrier spacing configuration in accordance with example embodiments of the present disclosure. The method 2400 may be performed by, e.g., a UE 111-116 of FIGS. 1 and 3. The embodiment of the example method illustrated in FIG. 24 is for illustration only. One or more of the components illustrated in FIG. 24 may be implemented in specialized circuitry configured to perform the noted functions or one or more of the components may be implemented by one or more processors executing instructions to perform the noted functions. Other embodiments of example methods for supporting subcarrier spacing configuration in data-aided transmissions could be used without departing from the scope of this disclosure.

As illustrated in FIG. 24, the method 2400 begins at step 2402. At step 2402, a UE may send UE capability information to a BS (e.g., the BS 101-103 of FIGS. 1 and 2). The UE capability information may include the support of the subcarrier spacing configuration for data-aided transmissions. At step 2404, the UE may receive a subcarrier spacing configuration message from a BS. At step 2406, the UE may transmit data and RS to a BS. In this case, the subcarrier spacing for the data and the RS may be determined by the subcarrier spacing configuration message.

FIG. 25 illustrates an example method 2500 of supporting a subcarrier spacing configuration in accordance with example embodiments of the present disclosure. The method 2500 may be performed by, e.g., a BS 101-103 of FIGS. 1 and 2. The embodiment of the example method illustrated in FIG. 25 is for illustration only. One or more of the components illustrated in FIG. 25 may be implemented in specialized circuitry configured to perform the noted functions or one or more of the components may be implemented by one or more processors executing instructions to perform the noted functions. Other embodiments of example methods for supporting subcarrier spacing configuration in data-aided transmissions could be used without departing from the scope of this disclosure.

As illustrated in FIG. 25, the method 2500 begins at step 2502. AT step 2502, a BS may receive UE capability information from a UE. The UE capability information may include the support of subcarrier spacing configuration. At step 2504, the BS may transmit a subcarrier spacing configuration message to the UE. An example of a subcarrier spacing configuration message is described in Table 3. At step 2506, the BS may receive data and RS from the UE. Here, the subcarrier spacing for the data and RS may be determined by the subcarrier spacing configuration message.

In one embodiment, a UE can indicate its support for subcarrier spacing configuration. Table 3 shows an example of modifying the BWP information element (IE) to indicate support of potentially different subcarrier spacing for data and RS. In this example, subcarrierSpacingData may correspond to the subcarrier spacing of data, while subcarrierSpacingRS may correspond to the subcarrier spacing of the RS.

TABLE 3
An example IE BWP modification to subcarrier
spacing configuration for data and RS

BWP: := SEQUENCE {

| | |
|---|---|
| locationAndBandwidth | INTEGER (0..37949) |
| subcarrierSpacingData | SubcarrierSpacing |
| subcarrierSpacingRS | SubcarrierSpacing |
| cyclicPrefix | ENUMERATED {extended } OPTIONAL |
| | -- Need R |

}

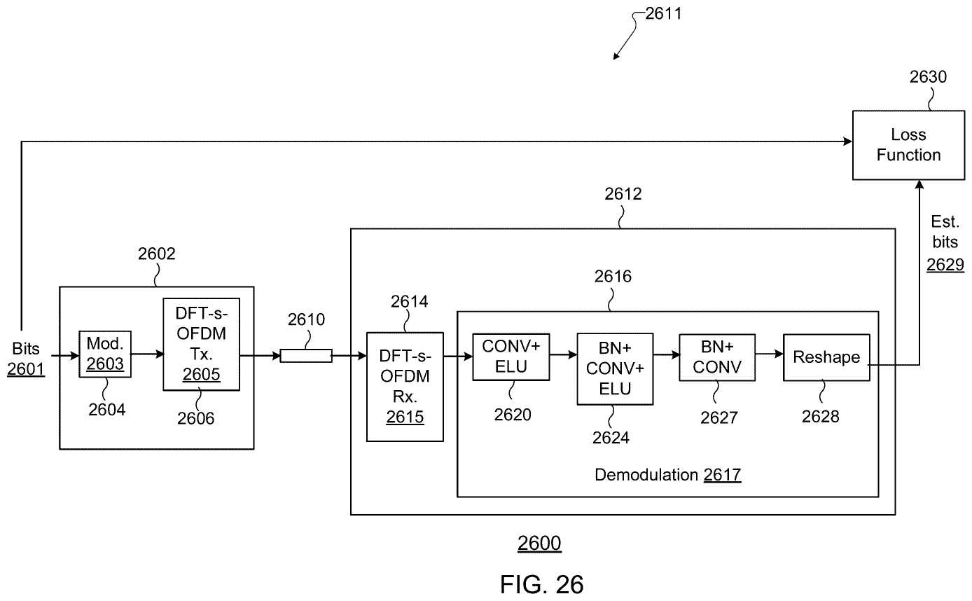

The example embodiments of an NN Rx (e.g., the NN Rx 716, 1016A-B, 1216A-B, 1416A-B, 1516A-B, 1616A-B, 1916A-B of FIGS. 7, 10A, 12A-C, 14-16 and 19) may be trained as illustrated in FIGS. 26-33.

FIG. 26 illustrates an example pipeline 2600 for training an NN Rx 2616 in a data-aided communication system 2611 accordance with example embodiments of the present disclosure. The embodiment of the example pipeline illustrated in FIG. 26 is for illustration only. One or more of the components illustrated in FIG. 26 may be implemented in specialized circuitry configured to perform the noted functions or one or more of the components may be implemented by one or more processors executing instructions to perform the noted functions. Other embodiments of example pipelines for training an NN Rx could be used without departing from the scope of this disclosure.

As illustrated in FIG. 26, the pipeline 2600 may include a modulation operation 2603, a DFT-s-OFDM transmission processing operation 2605, a DFT-s-OFDM reception processing operation 2615, a soft demodulation operation 2617, and a loss function 2630. The modulation operation 2603 and the DFT-s-OFDM transmission processing operation 2605 may be performed by a Tx architecture (e.g., the Tx architecture 702, 1002 of FIGS. 7 and 10A) and the DFT-s-OFDM reception processing operation 2615 and the soft-demodulation operation 2617 may be performed by an Rx architecture (e.g., the Rx architecture 712, 1012 of FIG. 7 or 10A). The loss function 2630 may be performed by the Rx architecture or a network server (e.g., the server 132 of FIGS. 1 and 4). More or less operations may be performed at the Tx architecture 2602 and/or the Rx architecture 2612.

In the example embodiment shown in FIG. 26, the bits 2601 may be input to the Tx architecture 2602 for the modulation operation 2603 and the DFT-s-OFDM transmission processing operation 2605. The processed OFDM symbols may be transmitted over a channel 2610 to the Rx architecture 2612. The DFT-s-OFDM receiver 2614 of the Rx architecture 2612 may perform the DFT-s-OFDM reception processing operation 2615 on the received symbols and input the processed symbols to the NN Rx 2616 for the soft demodulation operation 2617. The NN Rx 2616 may be similar to the NN Rx 1216A, B of FIGS. 12B-D, but differs in that it includes a reshape function 2628. This is for illustration purposes only, and thus other example NNs may be utilized to perform soft demodulation without departing from the scope of this disclosure. While it is not shown in FIG. 26, the NN Rx 2616 may also include multiple ResNet in series as shown in FIG. 12C.

In this embodiment, the output of the NN Rx 2616 may include estimated bits 2629. The estimated bits 2629 may be passed to the loss function 2630. The loss function 2630 may compare the estimated bits 2629 with the bits 2601 that are input to the modulator 2604, and the resulting error may be utilized to update the weights of the NN Rx 2616.

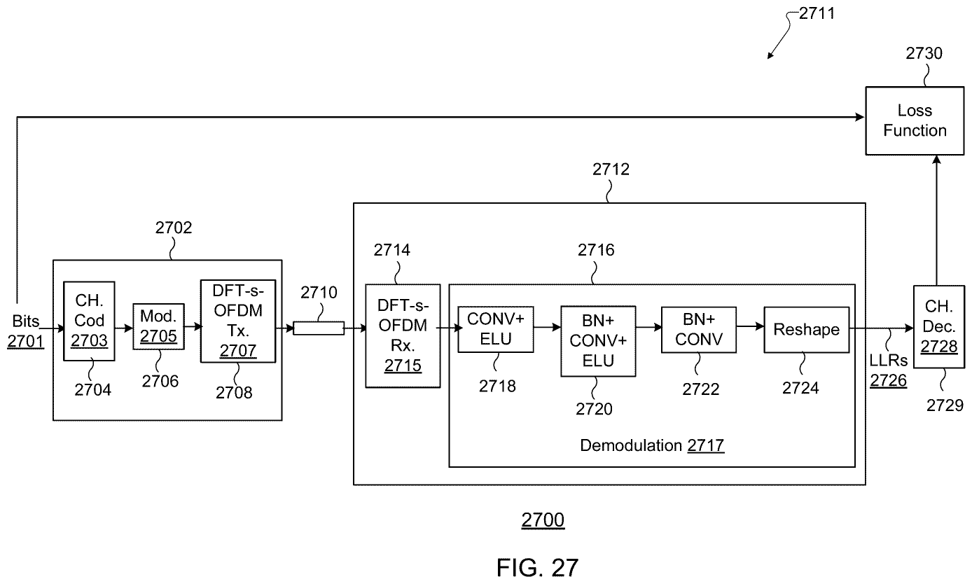

FIG. 27 illustrates an example pipeline 2700 for training an NN Rx 2716 with channel coding operation 2703 in a data-aided communication system 2711 in accordance with example embodiments of the present disclosure. The pipeline 2700 and the data-aided communication system 2711 are similar to the pipeline 2600 and the data-aided communication system 2611 of FIG. 26, except for the inclusion of the channel coding and decoding operations 2703 and 2728. The embodiment of the example pipeline illustrated in FIG. 27 is for illustration only. One or more of the components illustrated in FIG. 27 may be implemented in specialized circuitry configured to perform the noted functions or one or more of the components may be implemented by one or more processors executing instructions to perform the noted functions. Other embodiments of example pipeline for training an NN Rx could be used without departing from the scope of this disclosure.

As illustrated in FIG. 27, the pipeline 2700 may include a channel encoding operation 2703, a modulation operation 2705, a DFT-s-OFDM transmission processing operation 2707, a DFT-s-OFDM reception processing operation 2715, a soft demodulation operation 2717, a channel decoding operation 2728, and a loss function 2730. The channel encoding operation 2703, modulation operation 2705 and the DFT-s-OFDM transmission processing operation 2707 may be performed by a Tx architecture (e.g., the Tx architecture 702, 1002 of FIG. 7 or 10A) and the DFT-s-OFDM reception processing operation 2715, the soft-demodulation operation 2717 and the channel decoding operation 2728 may be performed by an Rx architecture (e.g., the Rx architecture 712, 1012 of FIG. 7 or 10A). The loss function 2730 may be performed by the Rx architecture or a network server (e.g., the server 132 of FIGS. 1 and 4). More or less operations may be performed at the Tx architecture 2702 and/or the Rx architecture 2712.

In the example embodiment shown in FIG. 27, the bits 2701 may be input to the Tx architecture 2702 for the channel coding operation 2703 by a channel coder 2704, the modulation operation 2705 by a modulator 2706 and the DFT-s-OFDM transmission processing operation 2707 by a DFT-s-OFDM Tx 2708. The processed OFDM symbols may be transmitted over a channel 2710 to the Rx architecture 2712. The DFT-s-OFDM Rx 2714 of the Rx architecture 2712 may perform the DFT-s-OFDM reception processing operation 2715 on the received symbols and input the processed symbols to the NN Rx 2716 for the soft demodulation operation 2717. The NN Rx 2716 may be similar to the NN Rx 2616 of FIG. 26, and include a reshape function 2724. This is for illustration purposes only, and thus other example NNs may be utilized to perform soft demodulation without departing from the scope of this disclosure. While it is not shown in FIG. 27, the NN Rx 2716 may also include multiple ResNet in series as shown in FIG. 12C.

In this embodiment, the output of the NN Rx 2716 may include LLRs 2726 that can be passed to the channel decoder 2729. The output of the channel decoder 2729 may include estimated bits that may be passed to the loss function 2730. The loss function 2730 may compare the estimated bits with the bits 2701 that are input to the channel coder 2704, and the resulting error may be utilized to update the weights of the NN Rx 2716.

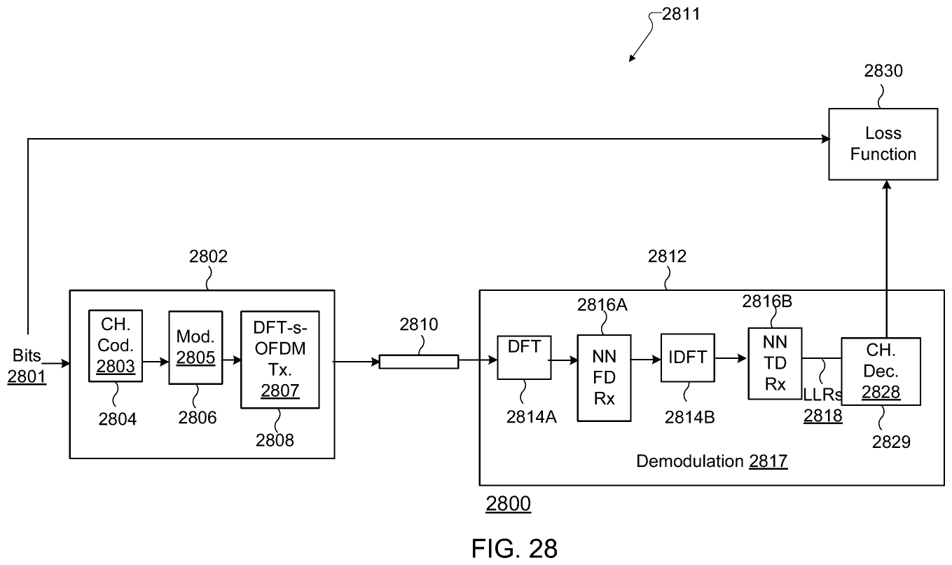

FIG. 28 illustrates an example pipeline 2800 for training a hybrid frequency-time NN Rx 2816A,2816B in a data-aided communication system 2811 in accordance with example embodiments of the present disclosure. The embodiment of the example pipeline illustrated in FIG. 28 is for illustration only. One or more of the components illustrated in FIG. 28 may be implemented in specialized circuitry configured to perform the noted functions or one or more of the components may be implemented by one or more processors executing instructions to perform the noted functions. Other embodiments of example pipeline for training an NN Rx could be used without departing from the scope of this disclosure.

The pipeline 2800 and the data-aided communication system 2811 are similar to the pipeline 2700 and the data-aided communication system 2711 of FIG. 27, except for the split domain processing 2814A,2814B and AI-based Rx operations 2816A,2816B. That is, the DFT-s-OFDM Rx may be split into a DFT block 2814A and an IDFT block 2814B, and the NN Rx may be split into an NN FD Rx 2816A and an NN TD Rx 2816B, similar to the NN Rx architectures of FIGS. 14-16 and 19.

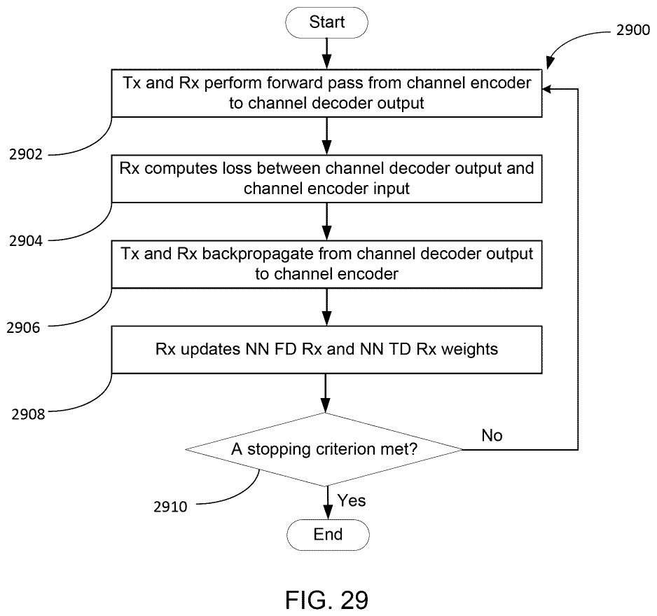

In the example embodiment shown in FIG. 28, the output of the NN TD Rx 2816B may include estimated bits that are passed initially to a channel decoder 2829 and then to a loss function 2830. The loss function 2830 may compare the estimated bits with the bits that are input to the modulator 2804, and the resulting error may be used to update the weights of the NN FD Rx 2816A and the NN TD Rx 2816B. An example training method for the NN Rx is discussed further in detail with reference to FIG. 29.

FIG. 29 illustrates an example method 2900 for training a hybrid frequency-time NN Rx for data-aided communications in accordance with example embodiments of the present disclosure. The method 2900 may be performed by any components (e.g., one or more processors 225, 340 or 415 of a BS 101-103, a UE 111-116 or a server 132 of FIGS. 1-4) of the data-aided communication system (e.g., the data-aided communication system 2811 of FIG. 28). The embodiment of the method illustrated in FIG. 29 is for illustration only. One or more of the components illustrated in FIG. 29 may be implemented in specialized circuitry configured to perform the noted functions or one or more of the components may be implemented by one or more processors executing instructions to perform the noted functions. Other embodiments of methods for training the NN Rx could be used without departing from the scope of this disclosure.

In the example shown in FIG. 29, the method 2900 begins at step 2902. At step 2902, a Tx architecture (Tx) and an Rx architecture (Rx) may perform a forward pass from the input of a channel encoder block to the output of a channel decoder block. At step 2904, the Rx may compute the loss between the channel decoder output and the channel encoder input. At step 2906, the Tx and the Rx may perform a backward pass from the channel decoder output to the channel encoder input. At step 2908, the Rx may utilize the backward pass to update the weights of the NN FD Rx and the NN TD Rx. At step 2910, the Tx and the Rx may repeat operations 2902, 2904, 2906 and 2908 until a stopping criterion is met.

One example of a stopping criterion at step 2910 may be the testing loss decreasing below a threshold. Another example of a stopping criterion may be the number of training epochs reaching a threshold.

In one example, a batch size of one TTI can be configured. In another example, a batch size of one TTI can be configured in conjunction with multiple steps per training epoch, where each step entails processing one batch.

In one example, the channel encoder can be located at a Tx, while the channel decoder, the NN FD Rx, and the NN TD Rx can be located at an Rx. In this case, steps 2902, 2904, 2906, 2908 and 2910 could support signaling between the Tx and the Rx.

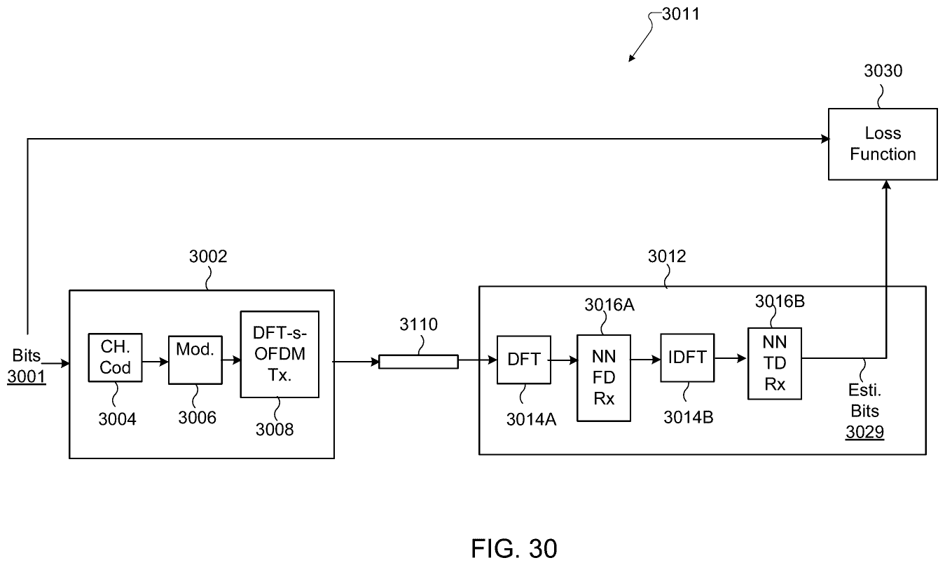

FIG. 30 illustrates an example pipeline 3000 for training a hybrid frequency-time NN Rx 3016A,3016B in a data-aided communication system 3011 with channel encoding in accordance with example embodiments of the present disclosure. The embodiment of the example pipeline illustrated in FIG. 30 is for illustration only. One or more of the components illustrated in FIG. 30 may be implemented in specialized circuitry configured to perform the noted functions or one or more of the components may be implemented by one or more processors executing instructions to perform the noted functions. Other embodiments of example pipeline for training an NN Rx could be used without departing from the scope of this disclosure.

The pipeline 3000 and the data-aided communication system 3011 are similar to the pipeline 2800 and the data-aided communication system 2811 of FIG. 28, except for the exclusion of a channel decoder.

In the example shown in FIG. 30, the output of the NN TD Rx 3016B may include estimated bits 3029 that are passed to a loss function 3030. The loss function 3030 may compare the estimated bits 3029 with the bits 3001 that are input to the channel coder 3004, and the resulting error may be utilized to update the weights of the NN FD Rx 3016A and the NN TD Rx 3016B. The NN TD Rx 3016B may essentially replace the channel decoder 2828 in FIG. 28.

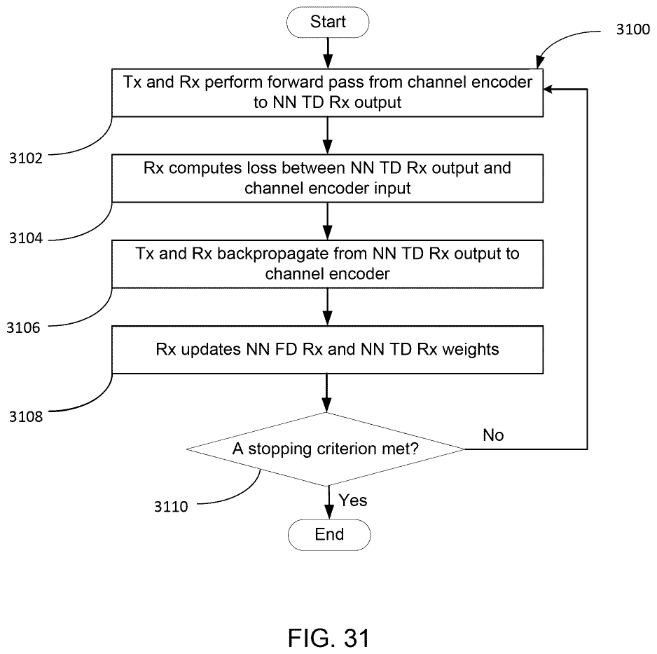

FIG. 31 illustrates an example method 3100 for training a hybrid frequency-time NN Rx for data-aided communications with channel encoding in accordance with example embodiments of the present disclosure. The method 3100 may be performed by any components (e.g., one or more processors 225, 340 or 415 of a BS 101-103, a UE 111-116 or a server 132 of FIGS. 1-4) of the data-aided communication system (e.g., the data-aided communication system 3011 of FIG. 30. The embodiment of the method illustrated in FIG. 31 is for illustration only. One or more of the components illustrated in FIG. 31 may be implemented in specialized circuitry configured to perform the noted functions or one or more of the components may be implemented by one or more processors executing instructions to perform the noted functions. Other embodiments of methods for training the NN Rx could be used without departing from the scope of this disclosure.

In the example shown in FIG. 31, the method 3100 begins at step 3102. At step 3102, a Tx and an Rx may perform a forward pass from the input of a channel encoder block to the output of an NN TD Rx. At step 3104, the Rx may compute the loss between the NN TD Rx output and the channel encoder input. At step 3106, the Tx and the Rx may perform a backward pass from the NN TD Rx output to the channel encoder input. At step 3108, the Rx may utilize the backward pass to update the model weights of the NN FD Rx and the NN TD Rx. At step 3110, the Tx and the Rx may repeat steps 3102, 3104, 3106 and 3108 until a stopping criterion is met.

One example of a stopping criterion in step 3110 may be the testing loss decreasing below a threshold. Another example of a stopping criterion may be the number of training epochs reaching a threshold.

In one example, a batch size of one TTI can be configured. In another example, a batch size of one TTI can be configured in conjunction with multiple steps per training epoch, where each step entails processing one batch.

In one example, the channel encoder can be located at a Tx, while the NN FD Rx and the NN TD Rx can be located at an Rx. In this example, steps 3102, 3104, 3106, 3108 and 3110 could support signaling between the Tx and the Rx.

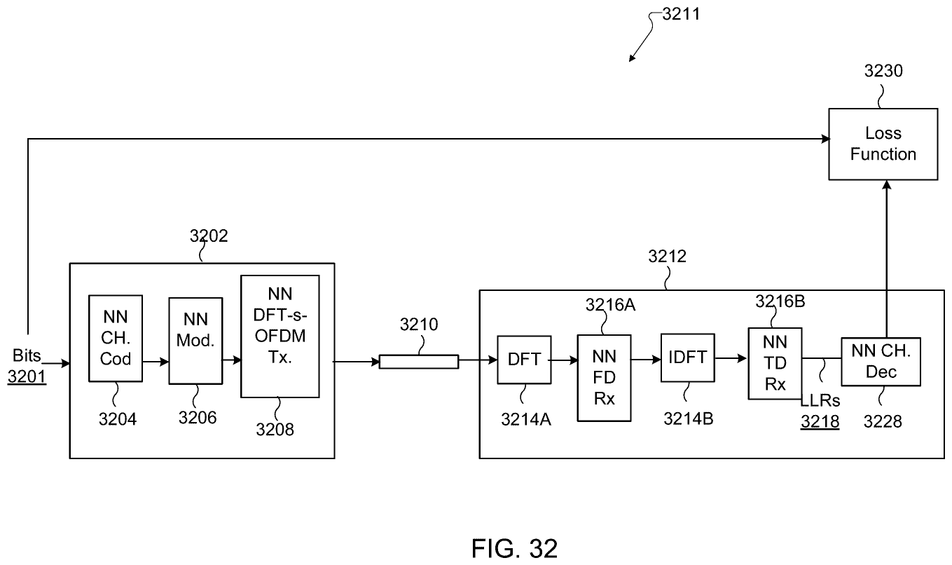

FIG. 32 illustrates an example pipeline 3200 for training a hybrid frequency-time NN Rx 3216A,3216B in a data-aided communication system 3211 with other AI/ML (NN) blocks in accordance with example embodiments of the present disclosure. The embodiment of the example pipeline illustrated in FIG. 32 is for illustration only. One or more of the components illustrated in FIG. 32 may be implemented in specialized circuitry configured to perform the noted functions or one or more of the components may be implemented by one or more processors executing instructions to perform the noted functions. Other embodiments of example pipeline for training an NN Rx could be used without departing from the scope of this disclosure.

The pipeline 3200 and the data-aided communication system 3211 are similar to the pipeline 2800 and the data-aided communication system 2811 of FIG. 28, except that the channel coder, the modulator, the DFT-s-OFDM Tx, and/or the channel decoder may be AI/ML based (i.e., NNs).

In the example shown in FIG. 32, the NN FD Rx 3216A, the NN TD Rx 3216B, and one or more of the NN channel coder 3204, the NN modulator 3206, the NN DFT-s-OFDM Tx 3208, and/or the NN channel decoder 3228 may be trainable.

In one example, the NN FD Rx 3216A, the NN TD Rx 3216B, and the NN channel coder 3204, the NN modulator 3206, the NN DFT-s-OFDM Tx 3208, and/or the NN channel decoder 3228 can be trained end-to-end.

In another example, the NN FD Rx 3216A, the NN TD Rx 3216B, and one or more of the NN channel coder 3204, the NN modulator 3206, the NN DFT-s-OFDM Tx 3208, and/or the NN channel decoder 3228 can be alternately trained, where the weights of one block are trained while the weights of all other blocks are fixed.

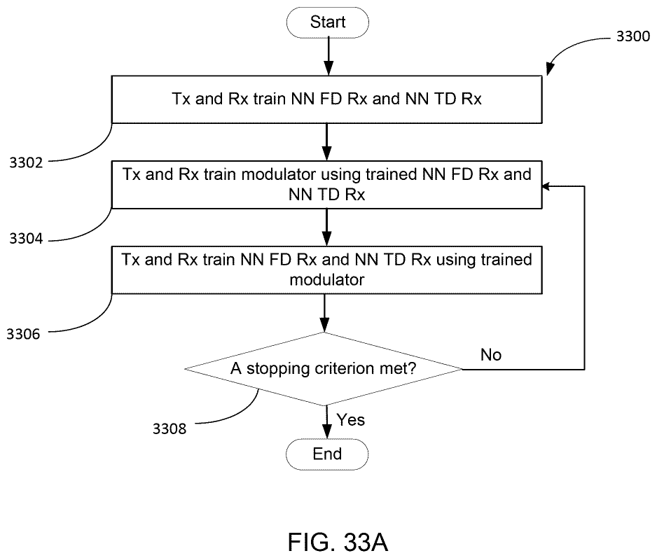

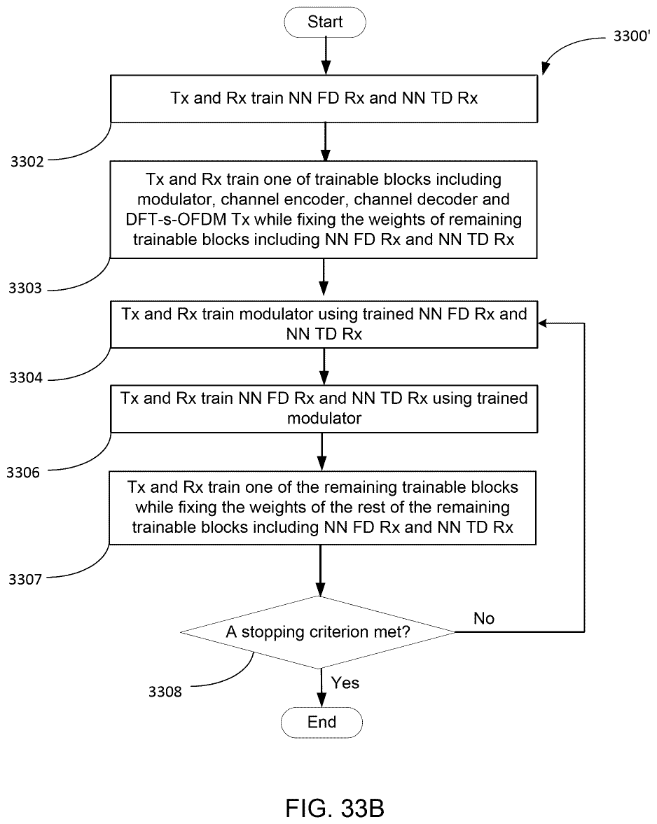

FIGS. 33A-B illustrate example methods 3300, 3300′ for training a hybrid frequency-time NN Rx and an NN modulator in accordance with example embodiments of the present disclosure. The methods 3300, 3300′ may be performed by one or more components (e.g., one or more processors 225, 340 or 415 of a BS 101-103, a UE 111-116 or a server 132 of FIGS. 1-4) of the data-aided communication system (e.g., the data-aided communication system 3211 of FIG. 32. The embodiments of the methods illustrated in FIGS. 33A-B are for illustration only. One or more of the components illustrated in FIGS. 33A-B may be implemented in specialized circuitry configured to perform the noted functions or one or more of the components may be implemented by one or more processors executing instructions to perform the noted functions. Other embodiments of methods for training the NN Rx could be used without departing from the scope of this disclosure.

In the examples shown in FIG. 33A, the method 3300 begins at step 3302. At step 3302, a Tx and an Rx may train an NN FD Rx and an NN TD Rx with a fixed NN modulator. At step 3304, the Tx and the Rx may train the NN modulator with the trained NN FD Rx and NN TD Rx. At step 3306, the Tx and the Rx may train the NN FD Rx and the NN TD Rx with the trained NN modulator. At step 3308, the Tx and the Rx may repeat steps 3304 and 3306 until a stopping criterion is met.

One example of a stopping criterion in step 3308 may be the testing loss decreasing below a threshold. Another example of a stopping criterion may be the number of training epochs reaching a threshold.

In one example, the modulator in steps 3304 and 3306 can be trained to produce a modulation constellation such as one of the modulation constellations in FIG. 6.

In one example, the modulator can be replaced by channel encoder and decoder blocks. In this case, the RS density in the DFT-s-OFDM Tx could depend on the trained channel coding rate.

In another example, the modulator can be replaced by a DFT-s-OFDM Tx block, where the RS density could be fixed while the RS pattern itself could be trained.

In another example, the Tx may configure one or more of the modulator, the channel encoder, the channel decoder, and the DFT-s-OFDM Tx to be trainable. If at least two of these blocks are trainable, then between steps 3302 and 3304, the Tx can perform an additional operation at step 3303 as illustrated in FIG. 33B. In step 3303, the Tx can train another block while fixing the weights of all other trainable blocks, including the NN FD Rx and the NN TD Rx. Also, between steps 3306 and 3308, the Tx can perform an additional operation at step 3307. At step 3307, the Tx can train another block while fixing the weights of all other trainable blocks, including the NN FD Rx and the NN TD Rx.

In one example, a batch size of one TTI can be configured. In another example, a batch size of one TTI can be configured in conjunction with multiple steps per training epoch, where each step entails processing one batch.

In one example, the modulator can be located at a Tx, while the NN FD Rx and the NN TD Rx can be located at an Rx. In this case, steps 3302, 3304, 3306 and 3308 could support signaling between the Tx and the Rx.

In one example, for step 3302, an Rx can train an NN FD Rx and an NN TD Rx without a Tx.

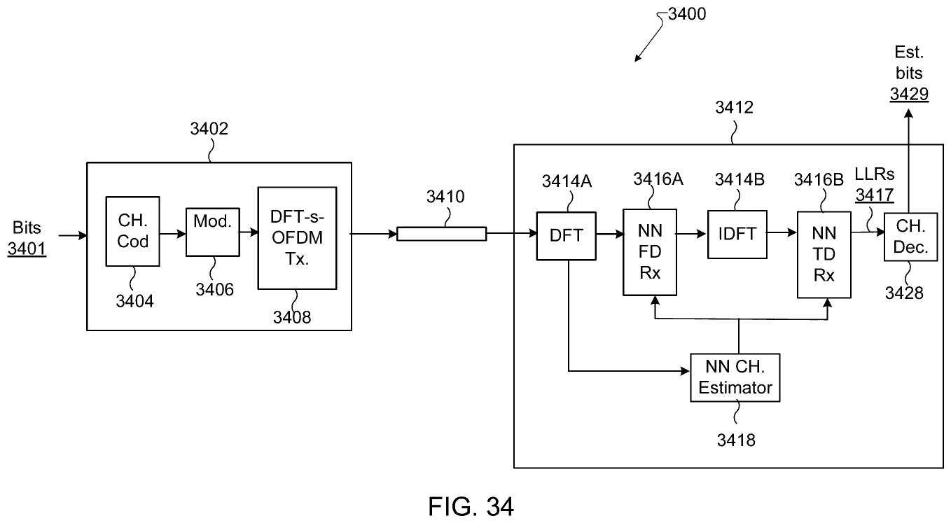

In the embodiments shown in FIGS. 11 and 12A-D, an Rx may utilize an NN FD Rx and an NN TD Rx to generate information about transmitted bits based on received data and/or RS. An alternative to the approach in FIG. 11 may entail an NN FD Rx and an NN TD Rx receiving additional information from a third NN Rx. In this alternative approach, the third NN Rx may generate estimates of the underlying wireless channel and pass those estimates to the NN FD Rx and/or the NN TD Rx as illustrated in FIG. 34.

FIG. 34 illustrates an example architecture of a hybrid frequency-time NN Rx 3416A, 3416B with an AI/ML channel estimator 3418 in a data-aided communication system 3400 in accordance with example embodiments of the present disclosure. The embodiment of the example architecture illustrated in FIG. 34 is for illustration only. One or more of the components illustrated in FIG. 34 may be implemented in specialized circuitry configured to perform the noted functions or one or more of the components may be implemented by one or more processors executing instructions to perform the noted functions. Other embodiments of NN Rx architectures for a data-aided communication system could be used without departing from the scope of this disclosure.

In the example illustrated in FIG. 34, the NN channel estimator 3418 may generate information about the underlying wireless channel that is passed as a secondary input to the NN FD Rx 3416A and the NN TD Rx 3416B, which may utilize the secondary input along with the outputs of the DFT block 3414A and the IDFT block 3414B to generate LLRs 3417 that are passed to the channel decoder 3428.

As an example, information about the underlying wireless channel may be the estimated channel values for REs in the time-frequency grid.

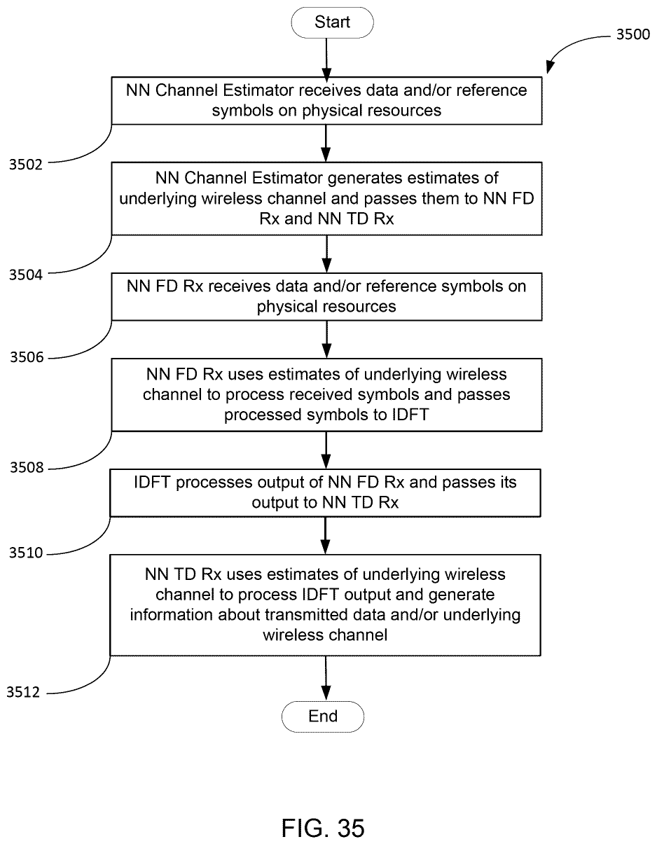

FIG. 35 illustrates an example method 3500 of data-aided communication performed by an Rx architecture with an AI/ML channel estimator in accordance with example embodiments of the present disclosure. The method 3500 may be performed by one or more components of the Rx architecture (e.g., the DFT block 3414A, the IDFT block 3414B, the NN FD Rx 3416A or the NN TD Rx 3416B of FIG. 34) of the data-aided communication system (e.g., the data-aided communication system 3400 of FIG. 34). The embodiment of the method illustrated in FIG. 35 is for illustration only. One or more of the components illustrated in FIG. 35 may be implemented in specialized circuitry configured to perform the noted functions or one or more of the components may be implemented by one or more processors executing instructions to perform the noted functions. Other embodiments of methods for training the NN Rx could be used without departing from the scope of this disclosure.

In the examples shown in FIG. 35, the method 3500 begins at step 3502. At step 3502, an NN channel estimator may receive data and/or RS on physical resources. One example of physical resources may be REs in a time-frequency grid that spans one TTI. At step 3504, the NN channel estimator may utilize the received data and/or RS to generate channel estimates and pass the channel estimates to the NN FD Rx and the NN TD Rx. At step 3506, the NN FD Rx may receive data and/or RS on physical resources. One example of physical resources may be REs in a time-frequency grid that spans one TTI. At step 3508, the NN FD Rx may utilize the generated channel estimates from step 3504 and the received data and/or RS to process the received data and/or RS and pass the processed symbols to the IDFT block. At step 3510, the IDFT block may process the output of the NN FD Rx and pass the IDFT block output to the NN TD Rx. At step 3512, the NN TD Rx may utilize the generated channel estimates from step 3504 and the IDFT block output to generate information about transmitted data and/or the underlying wireless channel.

In one example, the NN FD Rx and/or the NN TD Rx can be replaced by a non-AI/ML based receiver.

In one example, the generated information in step 3512 can include LLRs that can be passed to a channel decoder. In another example, the generated information can include soft-demodulated symbols. In another example, the generated information can include channel estimates. In another example, the generated information can include estimates of the transmitted bits.

In one example, the NN FD Rx and/or the NN TD Rx may include one or more layers that have been trained with a modulation constellation for data-aided communication and an error function.

In one example, at step 3504, the NN channel estimator can use the received data and/or RS to generate channel estimates and pass the channel estimates to the NN FD Rx or the NN TD Rx.

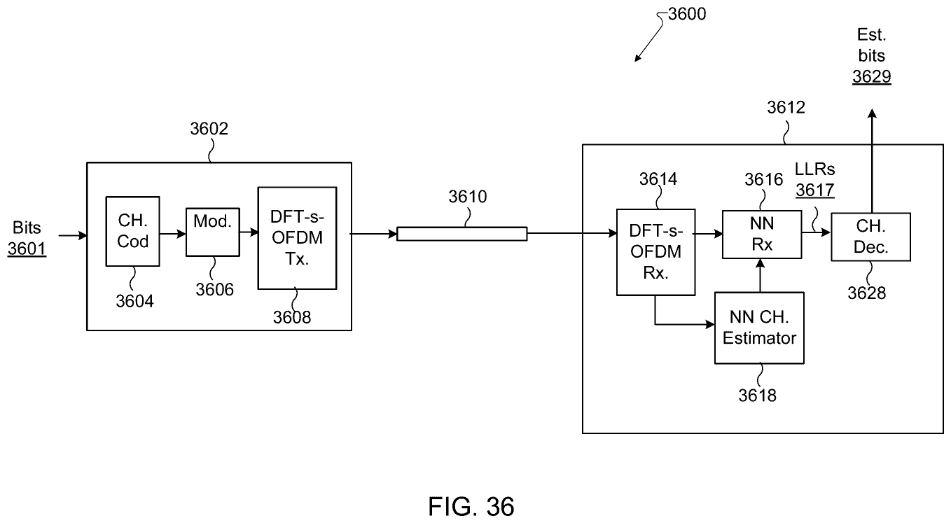

FIG. 36 illustrates an example architecture for a time-domain AI/ML Rx 3616 with an AI/ML channel estimator 3618 in a data-aided communication system 3600 in accordance with example embodiments of the present disclosure. The embodiment of the example architecture illustrated in FIG. 36 is for illustration only. One or more of the components illustrated in FIG. 36 may be implemented in specialized circuitry configured to perform the noted functions or one or more of the components may be implemented by one or more processors executing instructions to perform the noted functions. Other embodiments of NN Rx architectures for a data-aided communication system could be used without departing from the scope of this disclosure.

In the example illustrated in FIG. 36, the NN channel estimator 3618 may generate channel estimates that are passed as secondary inputs to the NN Rx 3616, which may utilize those secondary inputs along with the outputs of the DFT-s-OFDM Rx 3614 to generate LLRs 3617 that are passed to the channel decoder 3628.

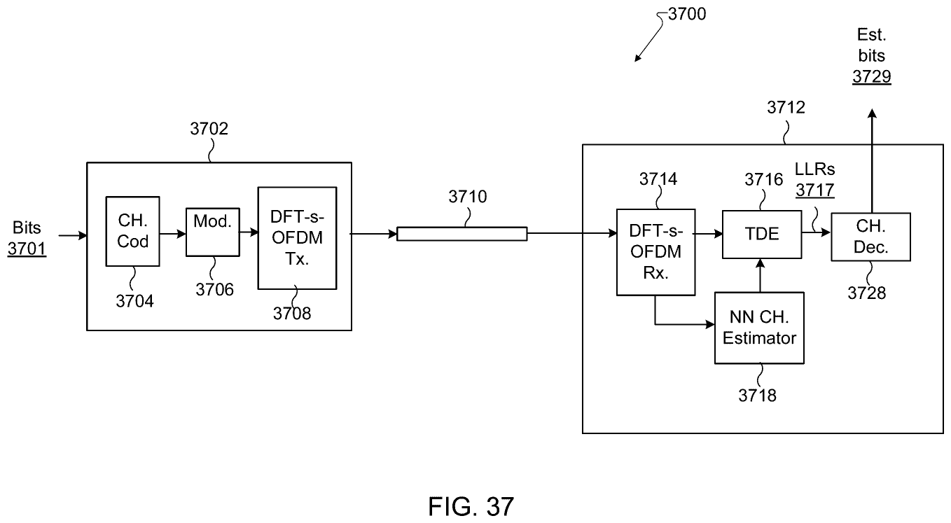

FIG. 37 illustrates an example architecture of a time-domain receiver 3716 with an AI/ML channel estimator 3718 in a data-aided communication system 3700 in accordance with example embodiments of the present disclosure. The embodiment of the example architecture illustrated in FIG. 37 is for illustration only. One or more of the components illustrated in FIG. 37 may be implemented in specialized circuitry configured to perform the noted functions or one or more of the components may be implemented by one or more processors executing instructions to perform the noted functions. Other embodiments of NN Rx architectures for a data-aided communication system could be used without departing from the scope of this disclosure.

In the example illustrated in FIG. 37, the NN channel estimator 3718 may generate channel estimates that are passed as secondary inputs to the TDE block, which may utilize those secondary inputs along with the outputs of the DFT-s-OFDM Rx 3714 to generate LLRs 3717 that are passed to the channel decoder 3728.

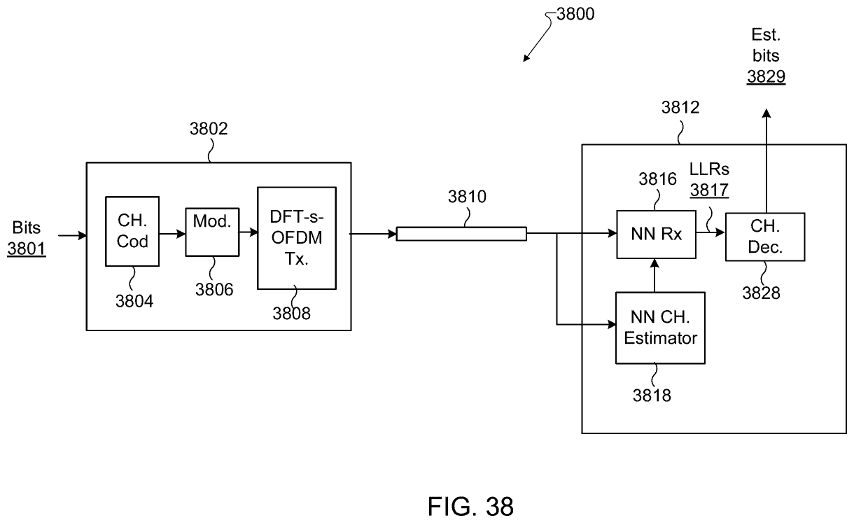

FIG. 38 illustrates an example architecture of a time-domain receiver 3816 with an AI/ML channel estimator 3818 in a data-aided communication system 3800 in accordance with example embodiments of the present disclosure. The embodiment of the example architecture illustrated in FIG. 38 is for illustration only. One or more of the components illustrated in FIG. 38 may be implemented in specialized circuitry configured to perform the noted functions or one or more of the components may be implemented by one or more processors executing instructions to perform the noted functions. Other embodiments of NN Rx architectures for a data-aided communication system could be used without departing from the scope of this disclosure.

In the example illustrated in FIG. 38, the NN channel estimator 3818 may generate channel estimates that are passed as secondary inputs to the NN Rx 3816, which may utilize those secondary inputs along with the outputs of the channel 3810 to generate LLRs 3817 that are passed to the channel decoder 3828. In this case, the DFT, subcarrier demapping, and IDFT steps that would be performed in a DFT-s-OFDM Rx may not be explicitly performed.

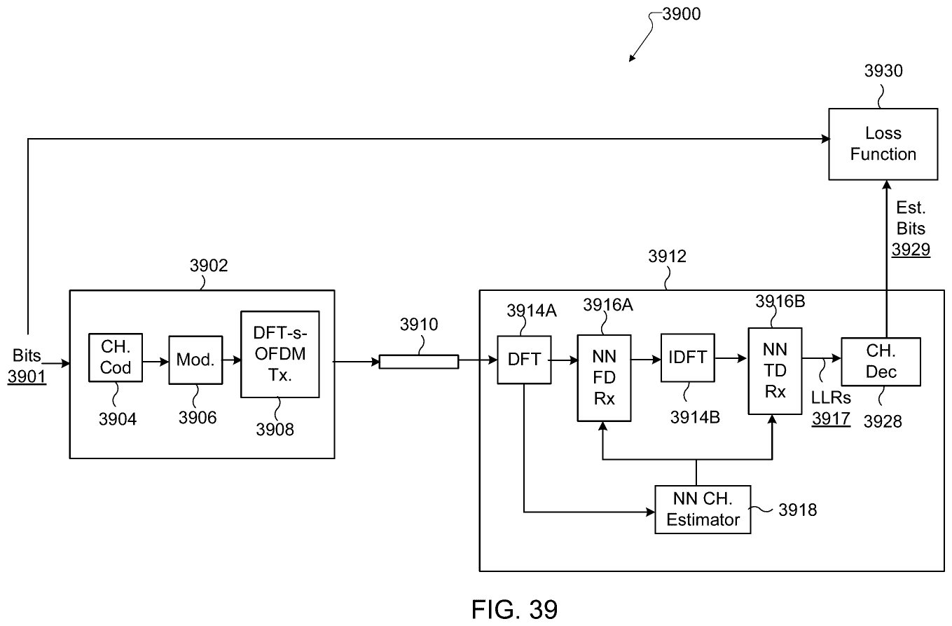

FIG. 39 illustrates an example pipeline for training a hybrid frequency-time AI/ML Rx 3916 with an AI/ML channel estimator 3918 in a data-aided communication system 3900 in accordance with example embodiments of the present disclosure. The embodiment of the example architecture illustrated in FIG. 39 is for illustration only. One or more of the components illustrated in FIG. 39 may be implemented in specialized circuitry configured to perform the noted functions or one or more of the components may be implemented by one or more processors executing instructions to perform the noted functions. Other embodiments of NN Rx architectures for a data-aided communication system could be used without departing from the scope of this disclosure.

In this case, the output of the NN TD Rx 3916B may include LLRs 3917 that are passed to a channel decoder 3928. The output of the channel decoder 3928 may include estimated bits 3929 that are passed to a loss function 3930. The loss function 3930 may compare the estimated bits 3929 with the bits 3901 that are input to the channel coder 3904. The resulting error may be utilized to update the weights of the NN FD Rx 3916A, the NN TD Rx 3916B and the NN channel estimator 3918 of a Rx 3912 with an AI/ML channel estimator 3918.

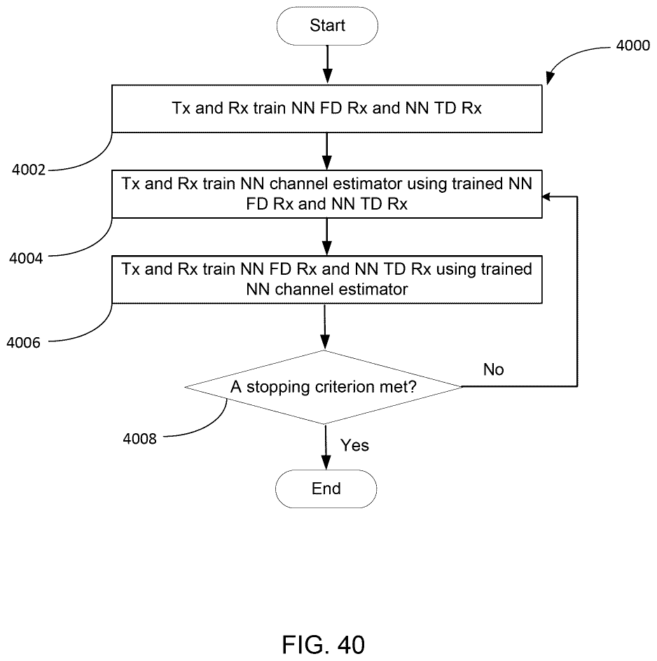

FIG. 40 illustrates an example method 4000 of training a hybrid frequency-time NN Rx and an NN modulator in accordance with example embodiments of the present disclosure. The method 4000 may be performed by one or more components (e.g., one or more processors 225, 340 or 415 of a BS 101-103, a UE 111-116 or a server 132 of FIGS. 1-4) of the data-aided communication system (e.g., the data-aided communication system 3900 of FIG. 39). The embodiment of the method illustrated in FIG. 40 is for illustration only. One or more of the components illustrated in FIG. 40 may be implemented in specialized circuitry configured to perform the noted functions or one or more of the components may be implemented by one or more processors executing instructions to perform the noted functions. Other embodiments of methods for training the NN Rx could be used without departing from the scope of this disclosure.

In the examples shown in FIG. 40, the method 4000 begins at step 4002. At step 4002, a Tx and an Rx may train an NN FD Rx and an NN TD Rx with a fixed NN channel estimator. At step 4004, the Tx and the Rx may train an NN channel estimator with a trained NN FD Rx and a trained NN TD Rx. At step 4006, the Tx and the Rx may train the NN FD Rx and the NN TD Rx with a trained NN channel estimator. At step 4008, the Tx and the Rx may repeat steps 4004 and 4006 until a stopping criterion is met.

One example of a stopping criterion in step 4008 may be the testing loss decreasing below a threshold. Another example of a stopping criterion may be the number of training epochs reaching a threshold.

In one example, a batch size of one TTI can be configured. In another example, a batch size of one TTI can be configured in conjunction with multiple steps per training epoch, where each step entails processing one batch.

In one example, the NN channel estimator, the NN FD Rx and the NN TD Rx can be located at an Rx. In this example, steps 4002, 4004, 4006 and 4008 may support signaling between a Tx and an Rx.

In one example, an Rx can train an NN FD Rx, an NN TD Rx, and an NN channel estimator without a Tx.

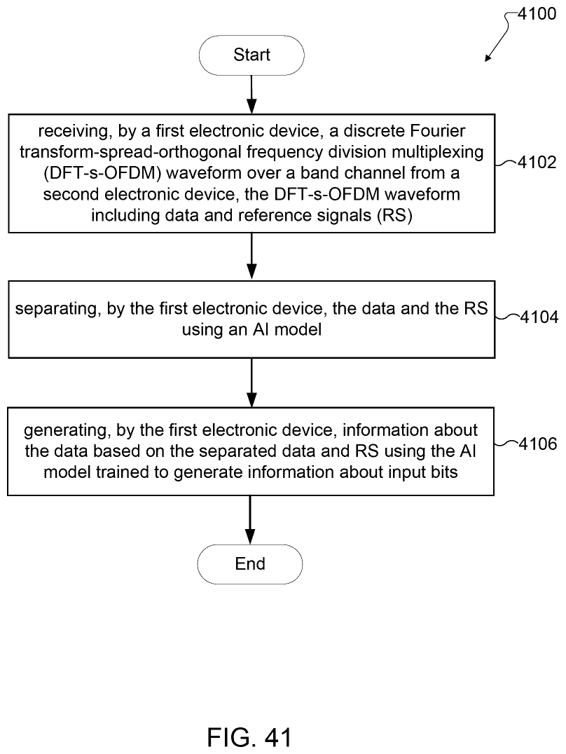

FIG. 41 illustrates an example flow chart for a method 4100 of generating information about input bits in accordance with example embodiments of the present disclosure. The method 4100 may be performed by a data-aided communication system (e.g., the data-aided communication system 700, 1000 of FIG. 7 or 10A) and any components thereof. An embodiment of the method illustrated in FIG. 41 is for illustration only. One or more of the components illustrated in FIG. 41 may be implemented in specialized circuitry configured to perform the noted functions or one or more of the components may be implemented by one or more processors executing instructions to perform the noted functions. Other embodiments of generating information associated with transmitted data using an NN Rx could be utilized without departing from the scope of this disclosure.

As illustrated in FIG. 41, the method 4100 begins at step 4102. At step 4102, a first electronic device (e.g., a gNB 101-103 of FIGS. 1 and 2) may receive a DFT-s-OFDM waveform over a band channel from a second electronic device, the DFT-s-OFDM waveform including data and RS. The second electronic device may be, e.g., a UE 111-116 of FIGS. 1 and 3). The first electronic device and/or the second electronic device may be AI-based.

At step 4104, the first electronic device may separate the data and the RS using an AI model. The AI model may be, e.g., the NN Rx 716, 1016A,1016B of FIG. 7 or 10A. In one embodiment, the data and the RS may be separated by an FD NN of the AI model receiving the data and the RS in the FD from a DFT block, generating data channels and RS channels to process the data channels and the RS channels separately, and outputting the processed data channels and the processed RS channels to an inverse DFT (IDFT) block to perform domain transform from the FD to a time domain (TD). This may also include the IDFT block passing TD data channels and TD RS channels to a TD NN of the AI model. This may further include the TD NN processing the TD data channels and TD RS channels. In one embodiment, the data and the RS may be separated by a DFT block performing DFT on an output of each of a plurality of receive antennas and passing real and imaginary outputs of the data and the RS to a frequency domain (FD) neural network (NN) of the AI model. This may also include the FD NN reducing a number of output channels based on one or more of receive-antenna combining and channel compensation, inputting reduced output channels to an inverse DFT (IDFT) to convert the output channels into a time domain (TD). This may further include the IDFT outputting TD output channels in separate TD data channels and TD RS channels. This may additionally include a TD NN processing the TD data channels and the TD RS channels.

At step 4106, the first electronic device may generate information about the data based on the separated data and RS using the AI model trained to generate information about input bits. In one embodiment, the information about the data may be generated by an FD NN of the AI model generating data channels and RS channels to perform channel estimation using the RS channels and compensate the data channels using the channel estimation, and outputting the compensated data channels and the RS channels to an inverse DFT (IDFT) block to convert the compensated data channel and the RS channels into a time domain (TD). This may also include the IDFT block generating TD data channels and TD RS channels to input to a TD NN of the AI model. This may further include the TD NN processing the TD data channels and the TD RS channels to perform additional channel compensation for the TD data channels.

In one embodiment, the first electronic device may also generate additional information including at least one of a signal to noise ratio estimates, channel estimates, delay spread estimates, Doppler shift estimates, and a class of channel model using the AI model including an FD NN and a TD NN. Further, the first electronic device may configure at least one of model architecture and weights of the FD NN and the TD NN.

In one embodiment, the first electronic device may also receive a capability report indicating subcarrier spacing configuration support from the second electronic device, and transmit a subcarrier spacing configuration to the second electronic device. Subcarrier spacing of the RS may be configured to be different (e.g., larger) from subcarrier spacing of the data.

In one embodiment, the AI model may be trained. This may include a corresponding processor of a data-aided transmission system performing a forward pass from a channel encoder input to a channel decoder output. The data-aided transmission system may include the first electronic device and the second electronic device. It may also include other electronic devices (e.g., a network server 132 of FIGS. 1 and 4) as appropriate without departing from the scope of this disclosure. The corresponding processor may compute a loss between the channel encoder input and the channel decoder output using a loss function, backpropagate from the channel decoder output to the channel encoder input, and update weights of an FD NN and a TD NN of the AI model based on the loss until a stopping criterion is satisfied. The FD NN may be configured to process FD data channels and FD RS channels. The TD NN may be configured to process TD data channels and TD RS channels.

In one embodiment, the first electronic device may further determine one or more explicit channel estimates based on the data and the RS using an AI-based channel estimator, pass the one or more explicit channel estimates to an FD NN and a TD NN of the AI model, and refine the generated information using the FD NN and TD NN based on the one or more explicit channel estimates.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims. None of the description in this application should be read as implying that any particular element, step, or function is an essential element that must be included in the claim scope. The scope of patented subject matter is defined only by the claims.

What is claimed is:

1. A method comprising:
receiving, by a first electronic device, a discrete Fourier transform-spread-orthogonal frequency division multiplexing (DFT-s-OFDM) waveform over a band channel from a second electronic device, the DFT-s-OFDM waveform including data and reference signals (RS);
separating, by the first electronic device, the data and the RS using an AI model; and
generating, by the first electronic device, information about the data based on the separated data and RS using the AI model trained to generate information about input bits.

2. The method of claim 1, wherein separating the data and the RS comprises:
receiving, by a frequency domain (FD) neural network (NN) of the AI model, the data and the RS in the FD from a DFT block;
generating, by the FD NN, data channels and RS channels to process the data channels and the RS channels separately;
outputting, by the FD NN, the processed data channels and the processed RS channels to an inverse DFT (IDFT) block to perform domain transform from the FD to a time domain (TD);
passing, by the IDFT block, TD data channels and TD RS channels to a TD NN of the AI model; and
processing, by the TD NN, the TD data channels and TD RS channels.

3. The method of claim 1, wherein separating the data and the RS comprises:
performing, by a DFT block, DFT on an output of each of a plurality of receive antennas;
passing, by the DFT block, real and imaginary outputs of the data and the RS to a frequency domain (FD) neural network (NN) of the AI model;
reducing, by the FD NN, a number of output channels based on one or more of receive-antenna combining and channel compensation;
inputting, by the FD NN, reduced output channels to an inverse DFT (IDFT) to convert the output channels into a time domain (TD);
outputting, by the IDFT, TD output channels in separate TD data channels and TD RS channels; and
processing, by a TD NN, the TD data channels and the TD RS channels.

4. The method of claim 1, wherein generating the information comprises:
generating, by a frequency domain (FD) neural network (NN) of the AI model, data channels and RS channels to perform channel estimation using the RS channels and compensate the data channels using the channel estimation;
outputting, by the FD NN, the compensated data channels and the RS channels to an inverse DFT (IDFT) block to convert the compensated data channel and the RS channels into a time domain (TD);
generating, by the IDFT block, TD data channels and TD RS channels to input to a TD NN of the AI model; and
processing, by the TD NN, the TD data channels and the TD RS channels to perform additional channel compensation for the TD data channels.

5. The method of claim 1, further comprising:
generating, by the first electronic device, additional information including at least one of a signal to noise ratio estimates, channel estimates, delay spread estimates, Doppler shift estimates, and a class of channel model using the AI model, the AI model including a frequency domain (FD) neural network (NN) and a time domain (TD) NN; and
configuring, by the first electronic device, at least one of model architecture and weights of the FD NN and the TD NN.

6. The method of claim 1, further comprising:
receiving, by the first electronic device, a capability report indicating subcarrier spacing configuration support from the second electronic device, and
transmitting, by the first electronic device, a subcarrier spacing configuration to the second electronic device, wherein subcarrier spacing of the RS is configured to be different from subcarrier spacing of the data.

7. The method of claim 1, wherein the AI model is trained by:
performing, by a corresponding processor of a data-aided transmission system including the first electronic device and the second electronic device, a forward pass from a channel encoder input to a channel decoder output;
computing, by the corresponding processor, a loss between the channel encoder input and the channel decoder output using a loss function;
backpropagating, by the corresponding processor, from the channel decoder output to the channel encoder input; and
updating, by the corresponding processor, weights of a frequency domain (FD) neural network (NN) and a time domain (TD) NN of the AI model based on the loss until a stopping criterion is satisfied, the FD NN configured to process FD data channels and FD RS channels, the TD NN configured to process TD data channels and TD RS channels.

8. The method of claim 1, further comprising:
determining, by the first electronic device, one or more explicit channel estimates based on the data and the RS using an AI-based channel estimator;
passing, by the first electronic device, the one or more explicit channel estimates to a frequency domain (FD) neural network (NN) and a time domain (TD) NN of the AI model; and
refining, by the first electronic device, the generated information using the FD NN and TD NN based on the one or more explicit channel estimates.

9. A first electronic device comprising:
a memory;
a processor operably coupled to the memory, the processor configured to:
receive a discrete Fourier transform-spread-orthogonal frequency division multiplexing (DFT-s-OFDM) waveform over a band channel from a second electronic device, the DFT-s-OFDM waveform including data and reference signals (RS);
separate the data and the RS using an AI model; and
generate information about the data based on the separated data and RS using the AI model trained to generate information about input bits.

10. The first electronic device of claim 9, wherein to separate the data and the RS, the processor is further configured to:
receive, using frequency domain (FD) neural network (NN) of the AI model, the data and the RS in the FD from a DFT block;
generate, using the FD NN, data channels and RS channels to process the data channels and the RS channels separately;
output, using the FD NN, the processed data channels and the processed RS channels to an inverse DFT (IDFT) block to perform domain transform from the FD to a time domain (TD);
pass, using the IDFT block, TD data channels and TD RS channels to a TD NN of the AI model; and
process, using the TD NN, the TD data channels and TD RS channels.

11. The first electronic device of claim 9, wherein to separate the data and the RS, the processor is further configured to:
perform, using a DFT block, DFT on an output of each of a plurality of receive antennas;
pass, using the DFT block, real and imaginary outputs of the data and the RS to a frequency domain (FD) neural network (NN) of the AI model;
reduce, using the FD NN, a number of output channels based on one or more of receive-antenna combining and channel compensation;
input, using the FD NN, reduced output channels to an inverse DFT (IDFT) to convert the output channels into a time domain (TD);
output, using the IDFT, TD output channels in separate TD data channels and TD RS channels; and
process, using a TD NN, the TD data channels and the TD RS channels.

12. The first electronic device of claim 9, wherein to generate the information, the processor is further configured to:
generate, using a frequency domain (FD) neural network (NN) of the AI model, data channels and RS channels to perform channel estimation using the RS channels and compensate the data channels using the channel estimation;
output, using the FD NN, the compensated data channels and the RS channels to an inverse DFT (IDFT) block to convert the compensated data channel and the RS channels into a time domain (TD);
generate, using the IDFT block, TD data channels and TD RS channels to input to a TD NN of the AI model; and
process, using the TD NN, the TD data channels and the TD RS channels to perform additional channel compensation for the TD data channels.

13. The first electronic device of claim 9, wherein the processor is further configured to:
generate additional information including at least one of a signal to noise ratio estimates, channel estimates, delay spread estimates, Doppler shift estimates, and a class of channel model using the AI model, the AI model including a frequency domain (FD) neural network (NN) and a time domain (TD) NN; and
configure at least one of model architecture and weights of the FD NN and the TD NN.

14. The first electronic device of claim 9, wherein the processor is further configured to:
receive a capability report indicating subcarrier spacing configuration support from the second electronic device, and
transmit a subcarrier spacing configuration to the second electronic device, wherein subcarrier spacing of the RS is configured to be different from subcarrier spacing of the data.

15. The first electronic device of claim 9, wherein the processor is further configured to:
determine one or more explicit channel estimates based on the data and the RS using an AI-based channel estimator;
pass the one or more explicit channel estimates to a frequency domain (FD) neural network (NN) and a time domain (TD) NN of the AI model; and
refine the generated information using the FD NN and TD NN based on the one or more explicit channel estimates.

16. A non-transitory computer readable medium embodying a computer program, the computer program comprising program code that, when executed by a processor of a first electronic device, causes the first electronic device to:
receiving, from a second electronic device, a discrete Fourier transform-spread-orthogonal frequency division multiplexing (DFT-s-OFDM) waveform over a band channel, the DFT-s-OFDM waveform including data and reference signals (RS);
separate the data and the RS using an AI model; and
generate information about the data based on the separated data and RS using the AI model trained to generate information about input bits.

17. The non-transitory computer readable medium of claim 16, wherein the program code that, when executed by the processor of the first electronic device, causes the first electronic device to separate the data and the RS comprises program code that, when executed by the processor of the first electronic device, causes the first electronic device to:
receive, using a frequency domain (FD) neural network (NN) of the AI model, the data and the RS in the FD from a DFT block;
generate, using the FD NN, data channels and RS channels to process the data channels and the RS channels separately;
output, using the FD NN, the processed data channels and the processed RS channels to an inverse DFT (IDFT) block to perform domain transform from the FD to a time domain (TD);
pass, using the IDFT block, TD data channels and TD RS channels to a TD NN of the AI model; and
process, using the TD NN, the TD data channels and TD RS channels.

18. The non-transitory computer readable medium of claim 16, wherein the program code that, when executed by the processor of the first electronic device, causes the first electronic device to separate the data and the RS comprises program code that, when executed by the processor of the first electronic device, causes the first electronic device to:
perform, using a DFT block, DFT on an output of each of a plurality of receive antennas;
pass, using the DFT block, real and imaginary outputs of the data and the RS to a frequency domain (FD) neural network (NN) of the AI model;
reduce, using the FD NN, a number of output channels based on one or more of receive-antenna combining and channel compensation;
input, using the FD NN, reduced output channels to an inverse DFT (IDFT) to convert the output channels into a time domain (TD);
output, using the IDFT, TD output channels in separate TD data channels and TD RS channels; and
process, using a TD NN, the TD data channels and the TD RS channels.

19. The non-transitory computer readable medium of claim 16, wherein the program code that, when executed by the processor of the first electronic device, causes the first electronic device to generate the information comprises program code that, when executed by the processor of the first electronic device, causes the first electronic device to:
generate, using a frequency domain (FD) neural network (NN) of the AI model, data channels and RS channels to perform channel estimation using the RS channels and compensate the data channels using the channel estimation;
output, using the FD NN, the compensated data channels and the RS channels to an inverse DFT (IDFT) block to convert the compensated data channel and the RS channels into a time domain (TD);
generate, using the IDFT block, TD data channels and TD RS channels to input to a TD NN of the AI model; and
process, using the TD NN, the TD data channels and the TD RS channels to perform additional channel compensation for the TD data channels.

20. The non-transitory computer readable medium of claim 16, further comprising program code that, when executed by the processor of the first electronic device, causes the first electronic device to:
receive a capability report indicating subcarrier spacing configuration support from the second electronic device, and
transmit a subcarrier spacing configuration to the second electronic device, wherein subcarrier spacing of the RS is configured to be different from subcarrier spacing of the data.
